(19) United States
(12) Patent Application Publication
(10) Pub. No.: US 2024/0419423 A1
(43) Pub. Date: Dec. 19, 2024

(54) DEPENDENCY BASED APPLICATION DEPLOYMENT

(71) Applicant: INTERNATIONAL BUSINESS MACHINES CORPORATION, ARMONK, NY (US)

(72) Inventors: Si Yu CHEN, Beijing (CN); Xiao Ling Chen, Beijing (CN); Juliet CANDEE, Brewster, NY (US); Hao WU, Beijing (CN)

(21) Appl. No.: 18/334,511

(22) Filed: Jun. 14, 2023

(51) Int. Cl. G06F 8/61; G06F 8/41

(52) U.S. Cl. CPC G06F 8/63; G06F 8/433

(57) ABSTRACT

Methods, computer program products, and systems are presented. The method computer program products, and systems can include, for instance: examining image layers of a container image and generating, in dependence on the examining, layer dependency relationship data that specifies layer dependency relationships of the container image; storing in a container repository the layer dependency relationship data that specifies layer dependency relationships of the container image; in response to receipt of a download request that specifies a targeted layer of the container image, analyzing relationship data of the layer dependency relationship data; in dependence on the analyzing, identifying a subset of image layers of the container image preceding the targeted layer; and establishing a deployment container image in dependence on the identified subset of image layers.

### BACKGROUND

Embodiments herein relate generally to application deployment and specifically to container based application deployment.

One method for virtualization is container based virtualization in which container virtual machines are deployed.

Container-based virtualization, also called operating system virtualization, is an approach to virtualization in which the virtualization layer runs as an application within an operating system. In this approach, the operating system's kernel can run on a physical computing node with several isolated application environments installed on top of it. The isolated guest application environments are called container.

Isolation between the containers occurs at multiple resources, such as at the file-system, the network stack subsystem, and one or more namespaces, but not limited thereto. By sharing the same running kernel and memory space there is virtually no difference between the performance of the “host” operating system and the containers.

A container image is generally understood to be an unchangeable, static file that includes executable code so it can run an isolated process on information technology (IT) infrastructure. The image, arguably the foundation of container technology, can be understood as a special file system. Images can be utilized to provide not various files, including but not limited to, programs, libraries, resources, and configuration files, which are executed by the container. Images can also include configuration parameters (e.g., anonymous volumes, environment variables, users, etc.), which the containers access during runtime.

### SUMMARY

Shortcomings of the prior art are overcome, and additional advantages are provided, through the provision, in one aspect, of a method. The method can include, for example: examining image layers of a container image and generating, in dependence on the examining, layer dependency relationship data that specifies layer dependency relationships of the container image; storing in a container repository the layer dependency relationship data that specifies layer dependency relationships of the container image; in response to receipt of a download request that specifies a targeted layer of the container image, analyzing relationship data of the layer dependency relationship data; in dependence on the analyzing, identifying a subset of image layers of the container image preceding the targeted layer; and establishing a deployment container image in dependence on the identified subset of image layers.

In another aspect, a computer program product can be provided. The computer program product can include a computer readable storage medium readable by one or more processing circuit and storing instructions for execution by one or more processor for performing a method. The method can include, for example: examining image layers of a container image and generating, in dependence on the examining, layer dependency relationship data that specifies layer dependency relationships of the container image; storing in a container repository the layer dependency relationship data that specifies layer dependency relationships of the container image; in response to receipt of a download request that specifies a targeted layer of the container image, analyzing relationship data of the layer dependency relationship data; in dependence on the analyzing, identifying a subset of image layers of the container image preceding the targeted layer; and establishing a deployment container image in dependence on the identified subset of image layers.

In a further aspect, a system can be provided. The system can include, for example a memory. In addition, the system can include one or more processor in communication with the memory. Further, the system can include program instructions executable by the one or more processor via the memory to perform a method. The method can include, for example: examining image layers of a container image and generating, in dependence on the examining, layer dependency relationship data that specifies layer dependency relationships of the container image; storing in a container repository the layer dependency relationship data that specifies layer dependency relationships of the container image; in response to receipt of a download request that specifies a targeted layer of the container image, analyzing relationship data of the layer dependency relationship data; in dependence on the analyzing, identifying a subset of image layers of the container image preceding the targeted layer; and establishing a deployment container image in dependence on the identified subset of image layers.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a container image repository, a graph driver, and a resource according to one embodiment;

FIG. 2 is an infrastructure implementation view of the system of FIG. 1 according to one embodiment;

FIG. 3 is an infrastructure implementation view of the system of FIG. 1 according to one embodiment;

FIG. 4 depicts a system having a container image repository, a graph driver, and a resource according to one embodiment;

FIG. 5A depicts an existing system according to one embodiment;

FIG. 5B depicts a container deployment system configured to facilitate selection of a subset of image layers of an historical container image according to one embodiment;

FIG. 6 is a flowchart illustrating operations of a graph driver interoperating with a container image repository, a resource, and a UE device according to one embodiment;

FIG. 7 depicts a relationship graph built by the graph driver according to one embodiment;

FIG. 8 depicts a relationship graph built by the graph driver according to one embodiment;

FIG. 9 is a spreadsheet that specifies file dependency and abstraction layer dependencies according to one embodiment;

FIG. 10 depicts a reduced relationship graph according to one embodiment;

FIG. 11 depicts a relationship graph built by the graph driver according to one embodiment;

FIGS. 12A-12B is a flowchart illustrating operations of a graph driver according to one embodiment;

FIG. 13 depicts a computing environment according to one embodiment.

### DETAILED DESCRIPTION

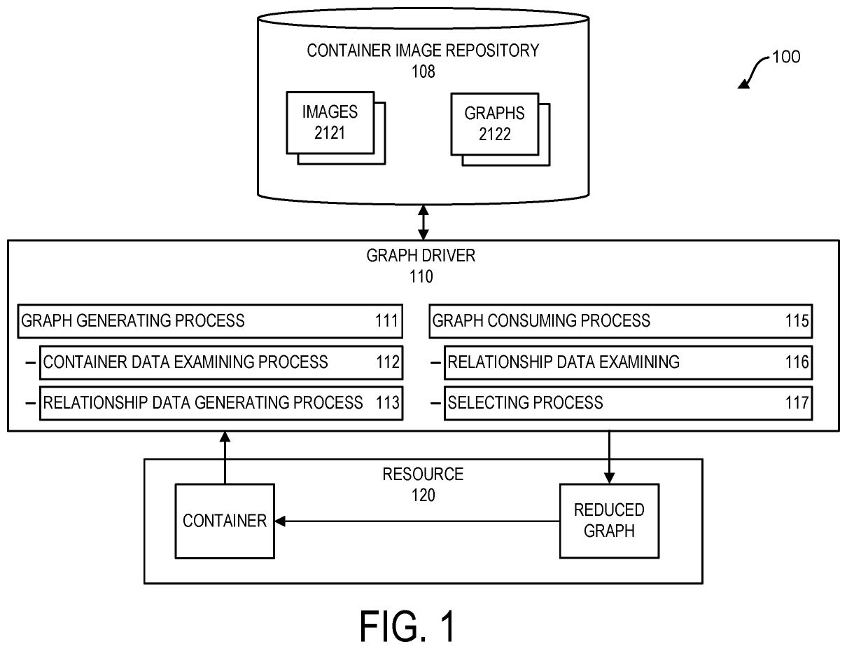

System 100 for deploying applications is shown in FIG. 1. System 100 can include container image repository 108 in communication with graph driver 110. Container image repository 108 can include images area 2121 for storage of container images and graphs area 2122 for storage of graphs. Graphs stored in graphs area 2122 can be provided by relationship graphs that specify attributes of an associated container image of container images area 2121. For respective container images in images area 2121, there can be stored an associated graph in graphs area 2122.

Graph driver 110 on the committing of a container image to container imager repository 108 can process a container image to generate a graph representing the container image and specifying attributes of a container image. For generating a new container, graph driver 110 can process a graph of graphs area 2122.

In some examples herein, including in the architecture of FIG. 1, program code can operate within graph driver 110. Graph driver 110 can enable a union file system. Graph driver 110 (which can be referred to as a storage driver) can be used in configuring layered container images. Graph driver 110 can consolidate multiple image layers into a root file system for the mount namespace of a container.

Graph driver 110 can run various processes. Graph driver 110 can run graph generating process 111 in order to generate graphs for storage into graphs area 2122 of container image repository 108. In one example, graph driver 110 can run graph generating process 111 responsively to committing a container image for storage of a container image into container image repository 108.

In one embodiment, graph driver 110 running graph generating process 111 can include graph driver 110 running container data examining process 112 for examination of container images. Graph driver 110 running container data examining process 112 can include (a) graph driver 110 ascertaining an order of image layers of a container image being committed for storage into container image repository 108, (b) graph driver 110 identifying file dependencies of image layers of the container image being processed and (c) graph driver 110 identifying abstraction layer dependencies of image layers of a container image being subject on being committed and submitted to container image repository 108.

Graph driver 110 running container data examining process 112 can include graph driver 110 running relationship data generating process 113. Graph driver 110 running relationship data generating process 113 can include graph driver 110 generating metadata that specifies attributes of a container image being committed into container image repository 108. The generated relationship data can define a graph for storage into graphs area 2122 of container image repository 108.

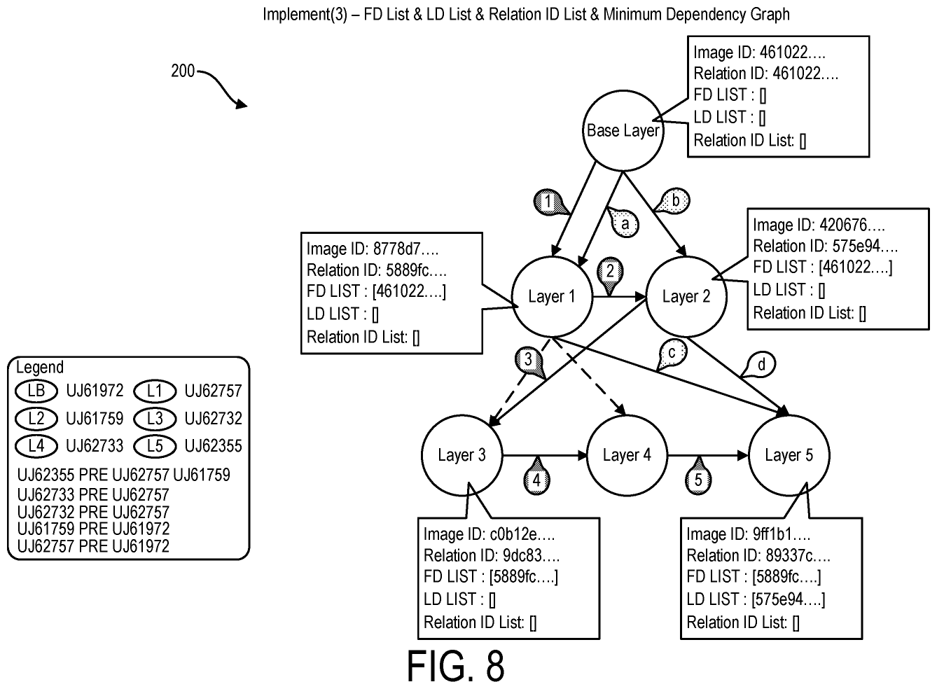

In one aspect, the metadata generated by running of metadata generating process 113 can include (i) metadata provided by relationship data that specifies an ordering of image layers of a container image being committed to image repository 102, (ii) metadata provided by relationship data that specifies file dependencies of image layers of a container image being committed to container image repository 108 and (iii) metadata provided by relationship data that specifies abstraction layer dependencies of a container image being committed to image repository 101. Graph driver 110 can organize the described metadata into the illustrated tree data structure of FIG. 7 defining a relationship graph 200 wherein nodes of the relationship graph 200 specify image layers of a container image being committed to container image repository 108, and wherein edges specify relationships between layers.

In one embodiment, graph driver 110 for determining submission relationships and ascertaining an ordering between image layers graph driver 110 can examine timestamped data that specifies a time of commitment and submission of an image layer.

For identifying file dependencies between image layers, graph driver 110 can determine whether a current image layer, and at least one other image layer modify a common file. For performing such identifying, graph driver 110 can perform container data processing, e.g., can examine text based build file code data, text based container image building logging data and/or text based runtime logging data. For identifying abstraction layer dependencies between image layers in one embodiment, graph driver 110 can examine container data, e.g., text based build file code data, text based container image building logging data and/or text based runtime logging data. For identifying abstraction layer dependencies between image layers, graph driver 110 for examining one or more image layer of a container image can read a manually raised flag raised by the administrator developer user that predetermines and forces the identification of an abstraction layer dependency between layers.

Embodiments herein recognize that image layers of a container image can feature dependencies other than file dependencies and that if such layer dependencies are not specified, various problems can occur. Embodiments herein recognize that if an image layer in abstraction layer dependency with a target image layer is not obtained, a user's function may be incomplete or unavailable.

In another aspect, graph driver 110 can perform graph consuming process 115. In one embodiment, graph driver 110 can run graph consuming process 115 in response to a request by a resource for an image layer. Such request can be defined by an administrator developer user who is using a user interface in communication with the resource. In response to a resource requesting a targeted image layer of an historical container image stored in images area 2121 of container image repository 108, graph driver 110 can run graph consuming process 115 to provide a reduced graph.

Graph driver 110 running graph consuming process 115 can include graph driver 110 running container relationship data examining process 116. Graph driver 110 running container relationship data examining process 116 can include graph driver 110 examining a certain graph of graphs area 2122 of container image repository 108, wherein the certain graph subject to examining is a graph associated to a container image of images area 2121 having a targeted layer targeted by a resource.

Graph driver 110 running container relationship data examining process 116 can include graph driver 110 generating a reduced graph as depicted in FIG. 1. The reduced graph can reference a reduced number of image layers relative to the certain graph subject to the described examining by container relationship data examining process 116. System 100 for deployment of an application can generate a container according to the reduced graph. For generating the reduced graph, graph driver 110 can run selecting process 117. Graph driver 110 running selecting process 117 can, based on a result of the relationship data examining process 116, select a subset of referenced layers from a relationship graph associated to repository stored container image having a targeted image layer. The selected subset of layers can include the targeted layer and a subset of layers of a repository stored historical container image preceding the targeted layer.

Embodiments herein recognize that images can be distributed to provide upgraded programmatic elements. As such, when a container image is committed, in existing systems, all the contents of the image layers can be pushed to a repository, e.g., container image repository 108, in the form of a container image. When pulling a container image from the repository, in an existing system, a consumer of the image (e.g., a resource in a computing system) can download all the contents of the specified image layers and all parent preceding layers to a local resource. Layers can include, but are not limited to, pervasive features, high impact/pervasive program temporary fixes (HIPER) features, recommended features, new features, and a base image. Because all parent preceding layers preceding a targeted layer are uploaded and/or downloaded together, even when only certain layers are being refreshed, the download will include all parent preceding layers preceding a targeted layer. Embodiments herein recognize that the necessity in existing systems of downloading and/or uploading all parent preceding layers preceding a targeted layer increases system overhead including container deployment time.

Additionally, when only a specific package (and not all updated packages) is desired to address a particular situation (e.g., a banking customer requires an update of HIPER features to address potential outages or security issues), updating an entirety of a resource introduces risk. Embodiments herein recognize that building specific images for all customers and situations is not a scalable solution. Thus, a need exists to deploy specific (targeted) applications on-demand via container images.

Embodiments herein can provide a system and method to deploy applications on-demand through container images. Unlike existing approaches, the examples herein enable a customized and targeted deployment to fulfill specific technical needs, rather than a blanket deployment of all parent preceding image layers of a targeted image layer, as the latter increases both system overhead and risk.

In some of the examples herein, program code of graph driver 110 executing on one or more processor can deploy updated services or layers on demand through containers. In embodiments herein, graph driver 110 can determine dependencies between image layers when generating and deploying containers such that a user can receive a more targeted container with current and/or interdependent layers, rather than a deployment that includes unnecessary overhead. To this end, as explained in greater detail herein, graph driver 110 can analyze layers for dependencies and can group interdependent changes within the layers based on both these dependencies and on when the changes were implemented (as compared to the last image refresh of the target machine).

For example, graph driver 110 can generate a relationship graph 200 provided by an ILDG (incremental layer directed graph) and utilize the ILDG to identify sequences of image layers (referred to herein as submissive sequences, file dependency sequences, and abstraction layer sequences) of the image layers. For determination of layer relationships, graph driver 110 can, e.g., perform monitoring the timing of uploading of image layers (e.g., timestamps), can determine files modified by an image layer, and/or can determine whether layers share data or a common resource. Graph driver 110 can deploy updated services or layers on demand through containers without including excess content in the deployments.

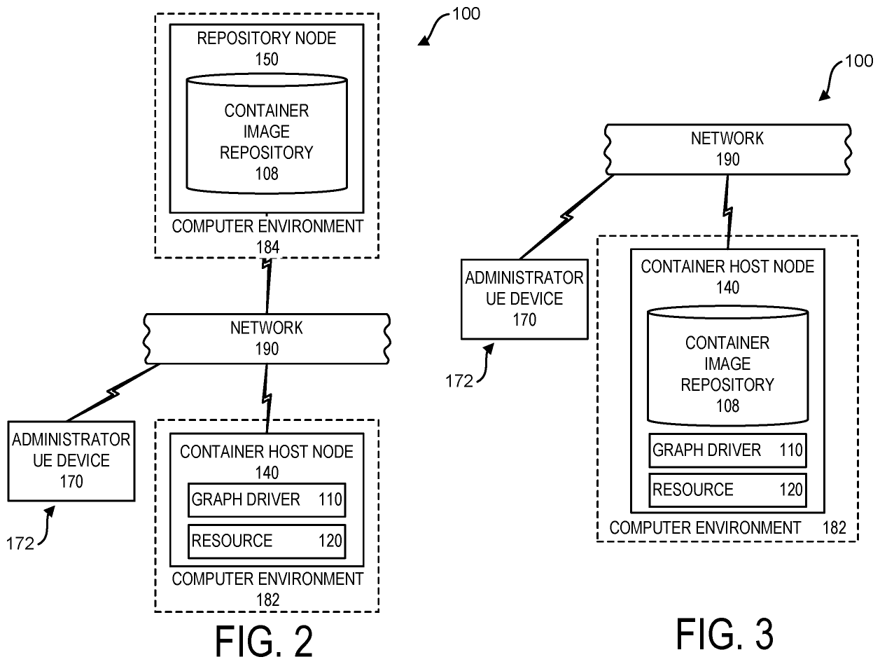

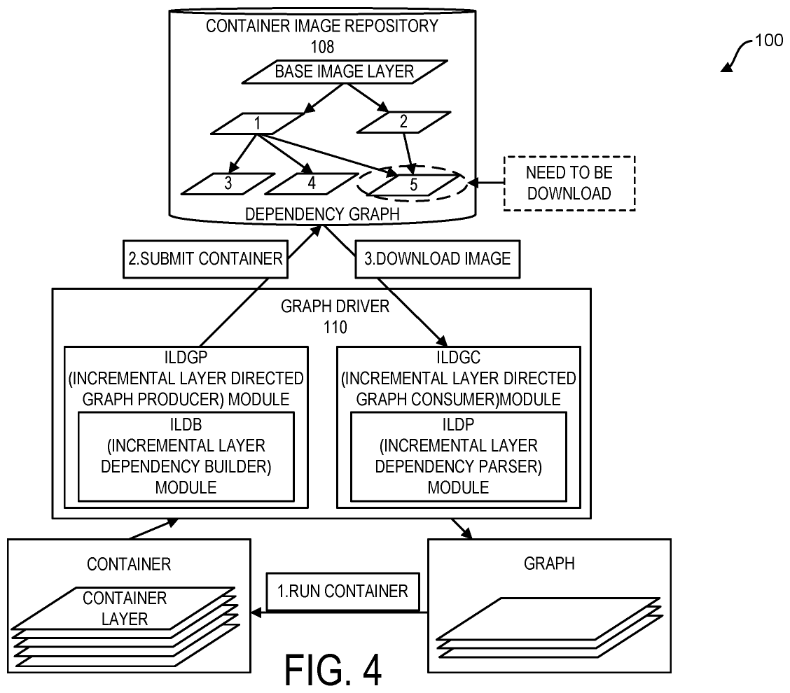

FIGS. 2 and 3 illustrate alternative infrastructure views of system 100. Referring to FIG. 2, graph driver 110 can run on container host node 140 defining a container host that runs containers, and container image repository 108 can run on a repository node 150. Container host node 140 can be disposed in a first computer environment 182 and repository node 150 and be disposed in a second computer environment 184. System 100 can include an administrator developer user equipment (UE) device 170 for use by a developer user. UE device 170 can define a user interface 172. User interface 172 can permit an administrator developer user to specify relationships between image layers, among other functions. Administrator UE device 170 defining user interface 172 can be configured, e.g., to permit user administrator developer user to configure resources to request image layers of historical container images stored in container image repository 108 and can also be configured, e.g., to permit the administrator developer user to specify administrator developer user defined dependencies between image layers of a container image in one embodiment.

Container host node 140, repository node 150 and administrator UE device 170 can be in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

In one embodiment, computer environment 182 can be a local computing local or otherwise private associated to an enterprise, and computer environment 184 can be a centralized computer environment, e.g., configured for access by multiple enterprises.

In one embodiment, container host node 140 can be provided by one or more computing node and repository node 150 can be provided by one or more computing node. The described computing nodes can be physical computing nodes. In one embodiment, the one or more computing node of repository node 150 can be external to the one or more computing node of the container host node 140. The described computing nodes can be physical computing nodes. In one embodiment, the one or more computing node of repository node 150 can be external and remote to the one or more computing node of the container host node 140.

In the embodiment of FIG. 3, container image repository 108 and graph driver 110 can commonly run on container host node 140 of first computing computer environment 182. Computer environment 182 can be a local or otherwise private computer environment, e.g., a private environment provided by a cloud services provider. System 100 can include an administrator developer user equipment (UE) device 170 for use by an administrator developer user. UE device 170 can define a user interface 172. User interface 172 can permit an administrator developer user to specify relationships between image layers, among other functions. Administrator UE device 170 defining user interface 172 can be configured, e.g., to permit user administrator developer user to configure resources to request image layers of historical container images stored in container image repository 108 and can also be configured, e.g., to permit the administrator developer user to specify administrator developer user defined dependencies between image layers of a container image in one embodiment. Container host node 140 and repository node 150, and administrator UE device 170 can be in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network. Container host node 140 can be provided by one or more computing node.

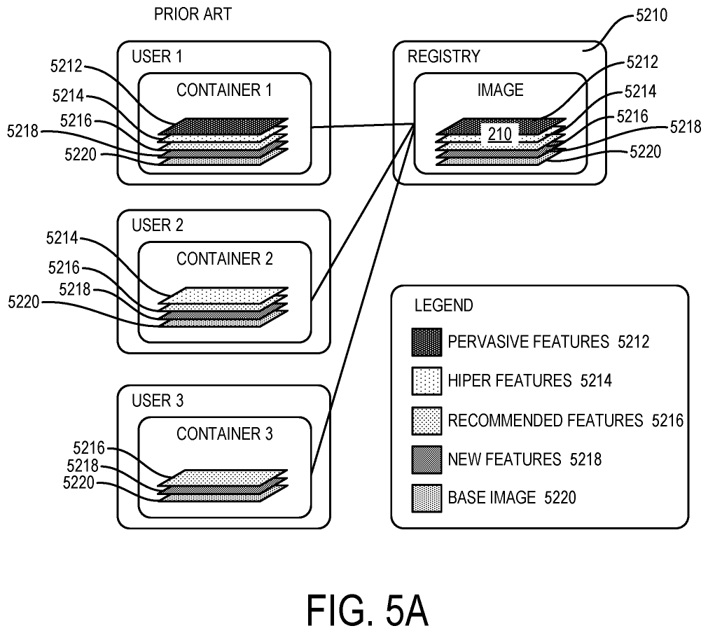

A schematic diagram of system 100 is shown in FIG. 4. Referring to FIG. 4 a container image can be run at (1). In response to container image being run, graph driver 110 at (2) can commit the container image to container image repository 108. With the committing of the container image to container image repository 108, graph driver 110 can process the container image using graph generating process 111 to generate a relationship graph for storage into graphs area 2122 of container image repository 108. At (3) a resource can request selective download of a certain image layer of a certain container image. In response to the request, graph driver 110 can run graph consuming process 115 to return a reduced graph.

With further reference to FIG. 4, graph generating process 111 can define an incremental layer directed graph producer (ILDGP) module which module can include an incremental layer dependency builder (ILDP) module. Graph driver 110 running graph consuming process 115 can define an incremental layer directed graph consumer (ILDGC) module, which can include an incremental layer dependency parser (ILDP) module.

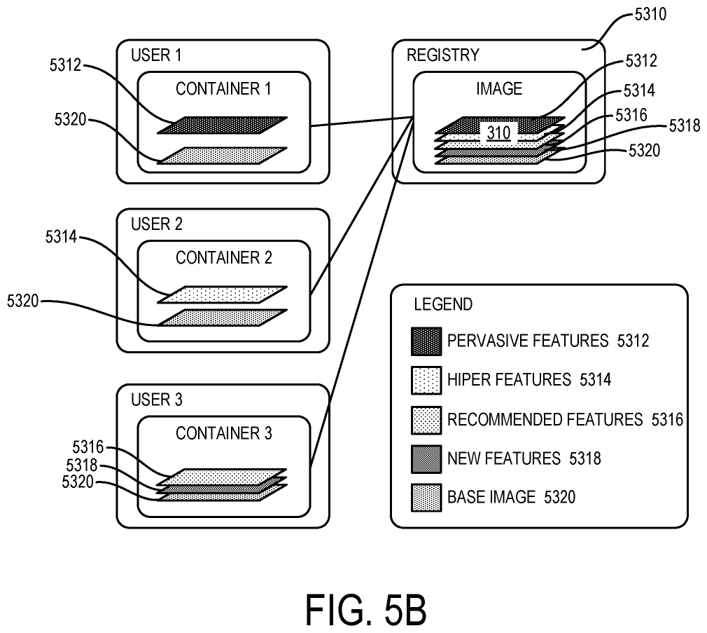

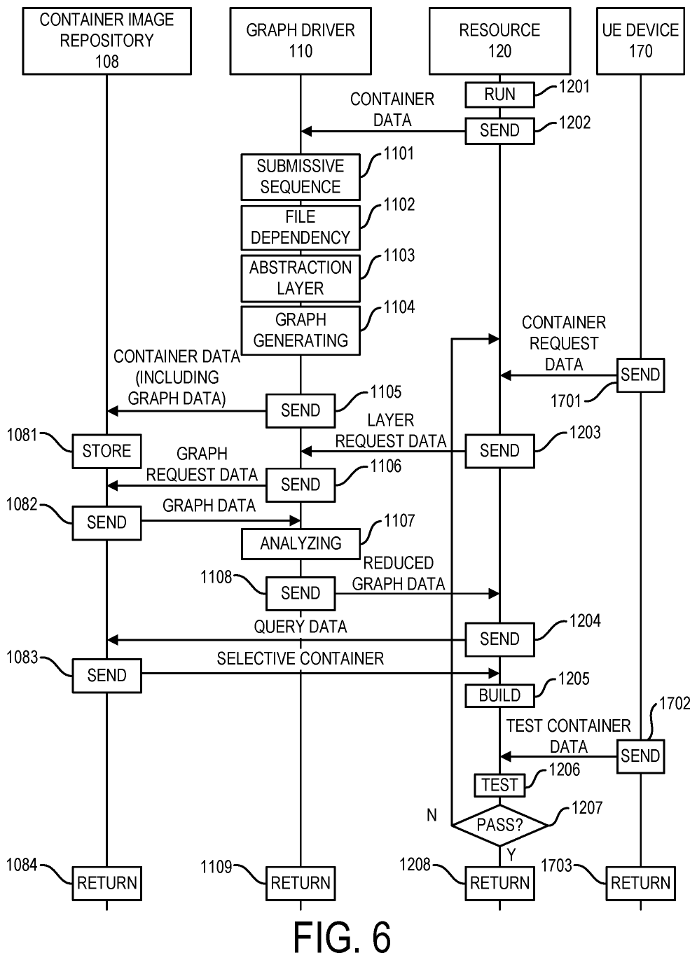

FIGS. 5A and 5B contrast existing techniques of generating containers with aspects of some embodiments of systems set forth herein. FIG. 5A illustrates an existing technique while FIG. 5B illustrates how the present examples of generating flexible on-demand containers generate containers that reduce the number of layers downloaded from an historical container image and the amount of data of image files by eliminating the inclusion of extraneous image layers in a container.

FIG. 5A illustrates the requirements of various users, user 1, user 2, and user 3 and how each of these users will be provided, by an existing system, from a registry 5210, with a container that includes image layers. In each case, the program code includes the image layers with the features sought by the user, but also all subsequent layers in the stack. In this example, registry 5210 storing a container image can include layers for pervasive features 5212, HIPER features 5214, recommended features 5216, new features 5218, and a base image 5220. In the example of FIG. 5A, user 1 desires pervasive features 5212, user 2 desires HIPER features 5214, and user 3 desires both recommended features 5216 and new features 5218. The program code in this existing system generates, from the registry 5210 a container, container 1 for user 1, which includes pervasive features 5212, HIPER features 5214, recommended features 5216, new features 5218, and a base image 5220. The program code in this existing system generates, from the registry 5210 container 2 for user 2, which includes HIPER features 5214, recommended features 5216, new features 5218, and a base image 5220. The program code in this existing system generates, from the registry 5210 container 3 for user 3, which includes recommended features 5216, new features 5218, and a base image 5219. Thus, for each user to obtain the desired features, the user must also obtain any features below and preceding that feature in the stack in the registry 5210.

FIG. 5B illustrates an example of the present technique in which the users can obtain containers with only the layers which they desire/request, and the base image. In FIG. 5B, user 1 desires from a stored container image in registry 5310 pervasive features 5312, user 2 desires HIPER features 5314, and user 3 desires both recommended features 5316 and new features 5318. The program code can generate, from the registry 5310 container 1 for user 1, which includes pervasive features 5312, and a base image 5320, container 2 for user 2, which includes HIPER features 5314 and a base image 5320, and container 3 for user 3, which includes recommended features 5316, new features 5318, and a base image 5320.

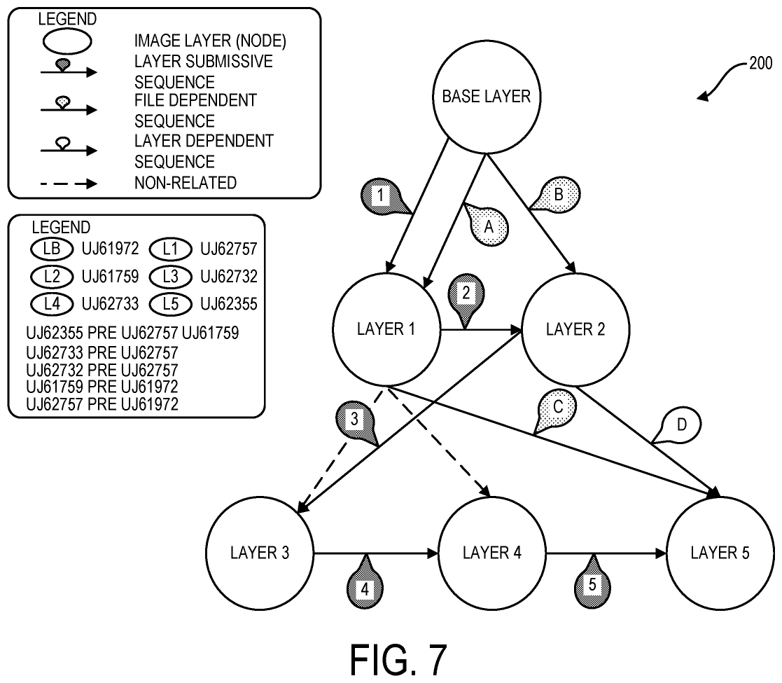

FIG. 6 is a flowchart illustrating a graph driver 110 interoperating with resource 120 and container image repository 108. At block 1201, resource 120 can run a container image designated as a runtime container. With the running of the container image, resource 120 can commit the container image to container image repository 108. Resource 120 for committing the container image can convert the container image's read/write layer into a read-only layer, which converts the container image into an immutable image. For committing of the container image, resource 120 at send block 1202 can send container data to graph driver 110 for processing by graph driver 110. Container data sent at block 1201 can include, e.g., text based build file code data, text based container image building logging data generated as a result of building and/or committing of a container image, text based runtime logging data generated as a result of running of a runtime container, and container image data such as, e.g., container binary image data, code, libraries, configuration files, and environment variables. A container image for committing to container image repository 108 can include a base layer (root layer) and child layers.

At block 1101, graph driver 110 can subject the received container data to time submission processing to determine relationship data in the form of a time based submissive sequence of a container image. A time based submissive sequence can refer to an order of commitment of layers of a container image. Processing at block 1101 to ascertain a time based submission sequence can include processing of each layer of a plurality of layers defining the container image. Graph driver 110 performing processing of each layer can include graph driver 110 comparing a timestamp specifying a time of commitment of the layer to timestamps specifying the time of commitment of remaining layers of the container image. Where graph driver 110 determines by timestamp analysis that a remaining layer was committed subsequent to a certain layer, graph driver 110 can record a time submissive relationship wherein the remaining layer is time submissive to the certain layer. Where graph driver 110 determines by timestamp analysis that a remaining layer was committed prior to a certain layer, graph driver 110 can record a time submissive relationship wherein the certain layer is time submissive to the remaining layer. A submissive sequence is a sequence that is based on a timestamp of uploading of the layer(s). The program code of graph driver 110 can generate a submissive sequence by searching a node's parent submissive nodes with the timestamp of uploading of the files. If a layer in container repository 108 was committed after a base layer, this layer is in a submissive sequence with the base layer. If a given layer is committed after a requested targeted layer, that given layer is in a submissive sequence to the requested targeted layer.

Based on the timestamp analysis specifying times of commitment of various layers, graph driver 110 can record a time submission sequence that specifies an order of commitment of layers of a plurality of layers defining a container image. Graph driver 110 can then use the determined order of uploading of layers for various purposes, e.g., for determining an ordering of examining layers for identifying file dependencies between layers, for determining an ordering of examining layers for identifying abstraction layer dependencies between layers, for determining an ordering of examining nodes associated to layers of a relationship graph, and for determining an ordering of downloading of layers.

In the example of FIG. 7, layer 1 (L1) was committed after the base layer (LB) and accordingly is time submissive to the base layer (LB). Layer 2 (L2) was committed after L1 and is time submissive to layer L1 and LB. Layer 3 (L3) was committed after layer L2 and is time submissive to layer L2, L1 and LB. Layer 4 (L4) was committed after L3 and is time submissive to layer L3, L2, L1 and LB. Layer 5 (L5) was committed after layer L4 and is time submissive to layer L4, L3 and L2, L1, and LB.

In another aspect, graph driver 110 at submissive sequence processing block 1101 can record for identified layers having timestamps, identifiers for the layers. For each layer identified for a plurality of layers defining a container image, graph driver 110 can record an image ID and a relationship ID. Graph driver 110 at submissive sequence processing block 1101 can assign each image layer a unique image identifier, image ID, and can also assign a relation ID to each layer. Graph driver 110 can calculate a relation ID for each layer by submitting all the ancestor submissive layers' image IDs through a hash algorithm (e.g., SHA256). For example, relation_ID_{L5}=SHA256 (Image_ID_{LB}+Image_ID_{L1}+ . . . +Image_ID_{L4}).

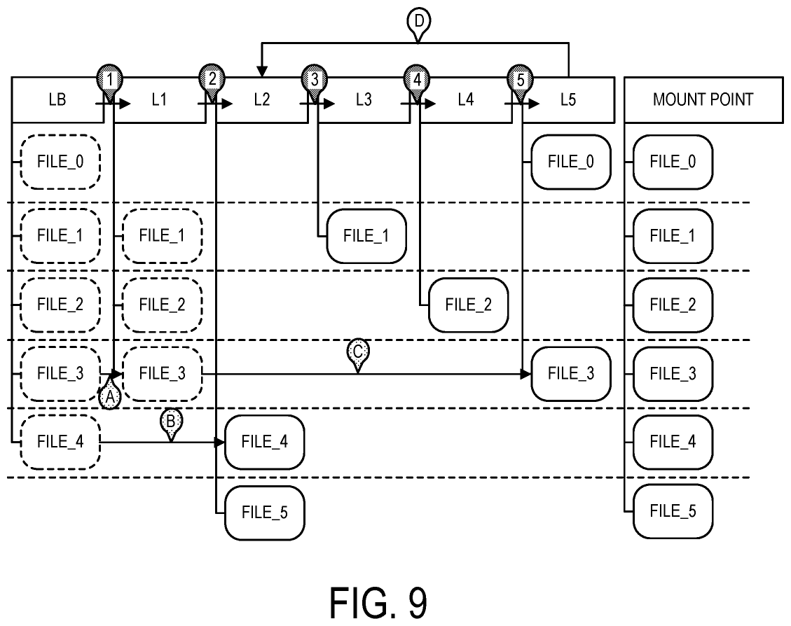

Accordingly, as illustrated in FIG. 8, the relation ID of a root layer (base layer) can be the same as its image ID. A relation ID can uniquely match and identify an image layer. As shown in FIG. 8, there can be recorded for each node associated to a layer, an image ID and a relation ID. Relations IDs for a sequence of layers can be used to verify the integrity of a download of a set of layers.

With reference again to FIG. 8, graph driver 110 can record relationship data in the form of time submission relationship sequences for layers determined to have time submission relationships. Time submission sequences can include a current layer and a sequence of layers identified as having time submission relationships back to the base layer. Graph driver 110 can record relation IDs to facilitate identification of a sequence of time submission related layers.

On completion of submissive sequence processing at block 1101, graph driver 110 can proceed to block 1102. At block 1102, graph driver 110 can perform file dependency processing to identify any file dependencies between any layers of a container image subject to uploading at block 1202. File dependency processing can include processing to ascertain whether any first and second layers of a container image modify a common file.

At block 1102 graph driver 110 can examine each layer of a set of layers defining a container image. Graph driver can examine layers at block 1102 according to an order determined by the submissive sequence processing at block 1101. For each certain layer of a container image, graph driver 110 can determine files modified by the certain layer, and can determine whether any remaining layers of the set of layers modifies a common file with the certain layer. Processing of container data at block 1102 can include processing, e.g., of text based build file code data, container image building logging data generated as a result of building and/or committing of a container image, and/or runtime logging data generated as a result of running of a runtime container. Where graph driver 110 ascertains that respective first and second layers modify a common file, graph driver 110 can record a file dependency between the first and second layers.

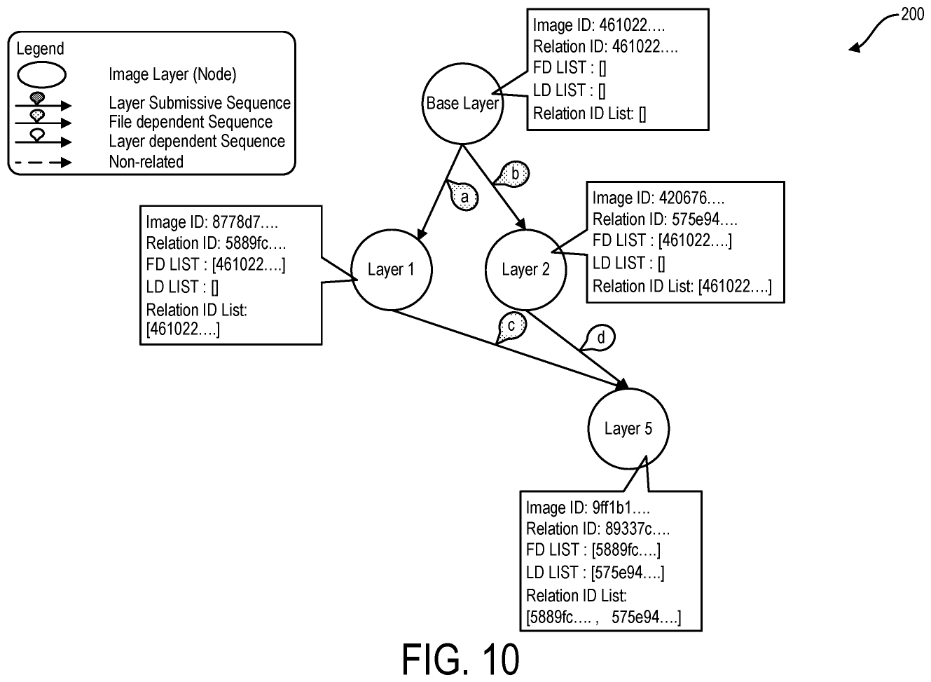

In the processing of container data at block 1101 and 1102, graph driver 110 can produce relationship data as summarized in the table of FIG. 9. In the table of FIG. 9, darkened textured numerical labels, 1, 2, 3, 4 and 5, depict layers in submissive sequence relation, and medium textured lettered characters depict layers in file dependency relation to one another. The table data of FIG. 9 can be produced, e.g., from logging data generated as a result of building and/or committing of a container image, and/or runtime logging data generated as a result of running of a runtime container. In tabulating files modified by the various labels, graph driver 110 can query the table of FIG. 9 to ascertain that LB and L1 commonly modify the file FILE_3 and can record a file dependency (A) between LB and L1, can query the table of FIG. 9 to ascertain that LB and L2 commonly modify the file FILE_4 and can record a file dependency (B) between LB and L2, can query the table of FIG. 9 to ascertain that L1 and L5 commonly modify the file FILE_3 and can record a file dependency (c) between LB and L1.

With reference again to FIG. 8, graph driver 110 can record file dependencies for layers determined to have file dependencies. Graph driver 110 can record a file dependency list (FD list) for each layer determined to be in file dependency with at least one other layer. The FD list for a certain layer can specify all layers having a direct file dependency relationship with the certain layer. An FD list for a given layer can include the relation ID for each image layer determined to be in file dependency with the given layer. File dependency sequences which can be determined by graph driver 110 using FD lists of various layers, can include a current layer and a sequence of layers identified as having file dependencies back to the base layer.

Referring to FIG. 8, the FD list specifying the file dependency sequence for layer 5 can list the relation ID for layer 1 (because layer 1 was determined to have file dependency with layer 5). Referring to FIG. 8, the FD list for layer 1 can list the relation ID for the base layer. Referring to FIG. 8, the FD list for layer 2 can list the relation ID for the base layer. By query of an FD list of a given layer, and by iteratively querying FD lists of preceding layers in file dependency with the queried layer back to the base layer, graph driver 110 can return of sequence of layers in file dependency relation, wherein the sequence comprises one, or more than one, preceding layer relative to the certain layer.

On completion of file dependency processing at block 1102, graph driver 110 can proceed to block 1103. At block 1103, graph driver 110 can perform abstraction layer dependency processing to identify any abstraction layer dependencies between any layers of a container image subject to uploading at block 1202.

While layers in file dependency relation can be regarded to have a physical layer dependency in an open systems interconnection (OSI) model context (in that dependency relates to a file stored in a storage system of a physical computing node), system 100 and graph driver 110 can be configured to determine and record image layer dependencies at one or more abstraction layer above the physical layer, which image layer dependencies are referenced herein as abstraction layer dependencies.

In one embodiment of an abstraction layer dependency, first and second layers can utilize, e.g., access, a common resource, e.g., a common file. In one embodiment of an abstraction layer dependency, first and second layers can share data between one another. For example, a compiler development team can deliver an updated dynamic library with new APIs on a first layer, then at a later time, another development team can deliver a second layer which calls an API located in the updated dynamic library which is provided by the compiler team on the first layer. In the described scenario, there is no file dependency between the first and second layer (the layers do not modify a common file), but graph driver 110 can be configured to record an abstraction layer dependency nonetheless. In one embodiment of an abstraction layer dependency, first and second layers can be regarded to feature an abstraction layer dependency based on first and second layers being complementary layers that feature runtime production advantages when operating together. For example, a first layer of a container image can be a data query layer and a second layer of a container image can be time sort layer, and what the customers want is that the query results are sorted by time. Accordingly, in such a scenario, graph driver 110 can record an abstraction layer dependency between the first and second layer. Accordingly, at block 1103, graph driver 110 can perform identifying layers of a container image for storage into container image repository 108 that are in abstraction layer dependency, wherein the layers of the container image that are in abstraction layer dependency include one or more of the following selected from the group consisting of (a) respective layers of the container image that use a common resource, (b) different layers of the container image, wherein a first of the different layers shares data with a second of the different layers, and (c) complementary layers of the container image that are complementary such that runtime production advantages are yielded when the complementary layers of the container image operate together.

FIG. 9 depicts abstraction layer dependencies between layers. Referring to FIG. 9, reference letter (D) (without texture) specifies an abstraction layer dependency between layer 2 and layer 5.

Graph driver 110 determining abstraction layer dependencies at block 1103 can include graph driver 110 processing, e.g., text based build file code data, container image building logging data generated as a result of building and/or committing of a container image, and/or runtime logging data generated as a result of running of a runtime container.

Additionally or alternatively, processing at block 1103 can include graph driver 110 for examining one or more image layer of a container image read a software flag defined by a developer user that specifies an image layer abstraction layer dependency. Such a software flag can be defined, e.g., with use of an administrator developer user interface 172 of administrator UE device 170 in developing a container image for uploading, as described herein in reference to block 1201. With the described software flag raised, the identification of an abstraction layer dependency can be predetermined and can be independent of any container data processing.

In one aspect, the identification of an abstraction layer dependency can benefit from or be facilitated by the presence of a software flag defined by an administrator developer user. The providing of user interface, e.g., user interface 172 as shown in FIGS. 2, 3 and 11 to facilitate the identification of abstraction layer dependencies can simplify identification of abstraction layer dependencies, and can avoid a need to identify abstraction layer dependencies via container data processing, e.g., by processing of software code associated to a container image, and/or processing of runtime logging data associated to a container image subject to uploading. Abstraction layer dependencies can include dependencies not identified by either timestamp analysis of uploading timestamps of various files, or by file modification analysis for determining that first and second layers modify a common file.

With reference again to FIG. 8, graph driver 110 can record abstraction layer dependencies for layers determined to be an abstraction layer dependency with one or more additional layer. Graph driver 110 can record an abstraction layer dependency list (LD list) to specify abstraction layer dependencies. Such an LD list for a certain layer can include the relation ID for each layer determined to be in direct abstraction layer dependency with the certain layer. Referring to FIG. 8, the LD list for layer 5 can record the relation ID for layer 2, which has been determined to be in abstraction layer dependency with layer 5. By query of an LD list of a given layer, and by iteratively querying LD lists of preceding layers in abstraction layer dependency with the queried layer back to the base layer, graph driver 110 can return of sequence of layers in abstraction layer dependency relation, wherein the sequence comprises one, or more than one, preceding layer. Embodiments herein recognize that if an image layer in abstraction layer dependency with a target image layer is not obtained, a user's function may be incomplete or unavailable.

On completion of abstraction layer processing block 1103, graph driver 110 can proceed to graph generating block 1104 to complete generation of a relationship graph 200 provided by an incremental layer directed graph (ILDG), examples of which are shown in FIGS. 7, 8 and 11. In one aspect, a generated relationship graph can express relationship data specifying layer relationships of a container image as a relationship graph 200 having nodes and edges, wherein nodes specify layers of a container image and edges specify relationships between various layers of a container image.

Graph driver 110 in various embodiments can build a relationship graph provided by a multiple hierarchy directed graph representing a container image referred to herein as an ILDG. This directed graph can include time submission relationship information derived from timestamps of the uploading of various layers of a container image. The relationship graph can also include file dependency information and/or abstraction layer dependency information.

FIGS. 7, 8 and 11 illustrate a relationship graph 200 of the type that can be generated by graph driver 110 as indicated by graph generating block 1104 for storage into graphs area 2122 of container image repository 108. The graphs of FIGS. 7, 8, and 11 are relationship graphs 200 having nodes that specify image layers of a container image and edges between the layers that specify relationships between image layers. Edges having numbers with dark texture specify time submissive sequence relationships between layers. Medium textured letters specify image layers that are in file dependency relation to other layers wherein image layers modify a common file. Edges labeled with untextured letters specify image layers that are in abstraction layer dependency.

As set forth in FIGS. 7 and 8, nodes of the relationship graph on block 1104 can specify the image ID for a layer associated to the node, the relation ID for the layer, and various lists. The lists can include, for each layer associated node, a file dependency (FD) list that specifies relation IDs for layers in file dependency relation to the layer, and an abstraction layer dependency list (LD list) that specifies relation IDs layers in abstraction layer dependency to the layer.

On completion of graph generating block 1104, graph driver 110 can proceed to send block 1105. At send block 1105, graph driver 110 can send container data to container image repository 108 for storage into container image repository 108. Container data sent at block 1104 can include, e.g., (i) container image data such as code, libraries, configuration files, and environment variables, container binary image data, (ii) text based build file code data, (iii) text based container image building logging data generated as a result of building and/or committing of a container image, (iv) text based runtime logging data generated as a result of running of a runtime container, and (v) relationship data defining the relationship graph generated at block 1101-1104. With the container image data, graph driver 110 can send relationship data generated by the examining at blocks 1101-1104. The container image data can be stored in images area 2121 of container image repository 108, and the remaining container data can be stored in graphs area 2122 of container image repository 108. The relationship data can include graph data defining a relationship graph 200.

At block 1701, a developer user can be using user interface 172 (FIGS. 2 and 3) to define container request data. Container request data can be defined with use of a webpage based user interface having a user interface webpage served by resource 120 that facilitates the ability of a developer user to author a container build file for building a new container image. In one example, the container build file can reference an historical targeted layer of an historical container image previously stored in container image repository 108. The historical container image referenced in the new container build file can be the historical container image stored in the most recent iteration of store block 1081 or at an earlier iteration of store block 1081.

On receipt of the container request data sent at block 1701, e.g., via a served webpage based user interface, resource 120 can produce a container build file for building a next container image for deployment, and can determine, e.g., via text based processing, that the container build file references a certain targeted layer from a certain historical container image stored in container image repository 108. Based on the identification of the targeted layer, graph driver 110 at block 1106 can send request data to container image repository 108 for a stored relationship graph associated to the certain historical container.

The request data sent at block 1203 can specify the container image of the historical container having the described targeted image layer and can specify the targeted image layer. In response to receipt of the request data sent at block 1203, graph driver 110 at send block 1105 can send graph request data requesting the stored relationship graph associated to the certain historical container image. In response to receipt of the request data sent at block 1106, container image repository 108 at block 1082 can send to graph driver 110 the requested graph data defining a relationship graph associated to the certain historical container.

On receipt of the sent relationship graph specifying relationships between layers, graph driver 110 at analyzing block 1107 can perform analyzing of the received relationship graph. The analyzing can include analyzing the relationship graph to identify a subset of layers specified in the relationship graph preceding the targeted layer for downloading. The analyzing can include producing a reduced graph that specifies the targeted layer and a subset of layers of the certain historical container image preceding the targeted layer. In one aspect the originally stored relationship graph for the certain historical container image can specify all layers of the certain historical container image including and preceding the targeted layer, and subsequent to the targeted layer. In one aspect, the subset of layers identified can include a subset of i.e., less than all layers of the certain historical container image preceding the targeted layer. In one aspect, layers selected for downloading from an historical container image can include the targeted layer of the certain historical container image, and a subset of layers preceding the targeted layer from the historical container image.

In the described example referencing FIGS. 7-11, the targeted certain historical layer can be layer 5. In one aspect for performing the analyzing at block 1107, graph driver 110 can analyze the received relationship graph for the certain historical container image to identify (a) container image layers of the historical container image having file dependencies and (b) container image layers of the historical container image having abstraction layer dependencies. Graph driver 110 can use the identified dependencies to determine a sequence of layers for downloading having a dependency relationship, wherein the sequence of layers for downloading include the targeted layer and a subset of preceding layers of the historical container image.

Based on the identifying at analyzing block 1107, graph driver 110 can produce a reduced graph having a reduced number of layer associated nodes preceding a targeted layer relative to that of an historical container image having the targeted layer.

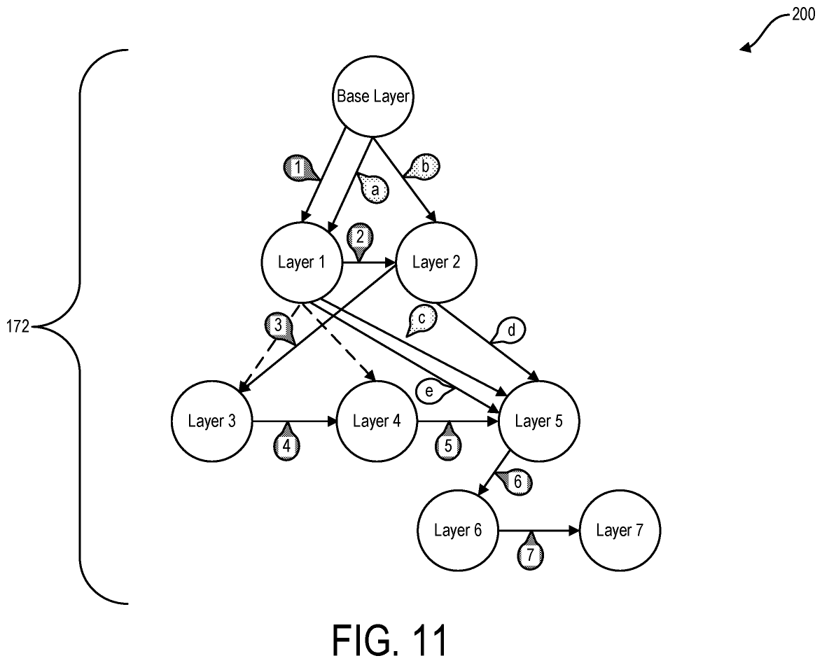

A reduced graph reduced from the graph of FIG. 8 is shown in FIG. 10. As shown by FIG. 10, the reduced graph of FIG. 10 is absent of nodes 3 and 4 for layer 3 and 4 respectively. The reduced graph can include the targeted layer and a subset of nodes preceding a targeted layer relative to the relationship graph of the historical container image as shown in FIGS. 7 and 8. Nodes 3 and 4 which precede targeted layer 5 can be removed from the relationship graph of FIG. 8 as a result of node 3 and 4 being absent of a dependency relationship in respect to the targeted layer, layer 5. Referring to FIG. 8, layer 1 can have a dependency relationship relative to layer 5 as a result of having a direct file dependency relationship with layer 5. Referring to FIG. 8, layer 2 can have a dependency relationship relative to layer 5 as a result of having a direct abstraction layer dependency relationship with layer 5. The base layer can have a dependency relationship relative to layer 5 as a result of having an indirect dependency relative to layer 5. The base layer can be indirectly dependent with respect to layer 5 through layer 1 by way of being in file dependency with layer 1, and with respect to layer 5 through layer 3 by way of being in file dependency with layer 2.

In regard to the user interface 172 described in reference to block 1701 permitting an administrator developer user to define features of a container build file, such user interface 172 can include features that permit an administrator developer user to specify dependencies between layers of a container image. In one aspect, user interface 172 can include features that permit a user to specify abstraction layer dependencies between layers. The described user interface 172 can permit a user to define a software flag specifying that any first and second layers are in abstraction layer dependency.

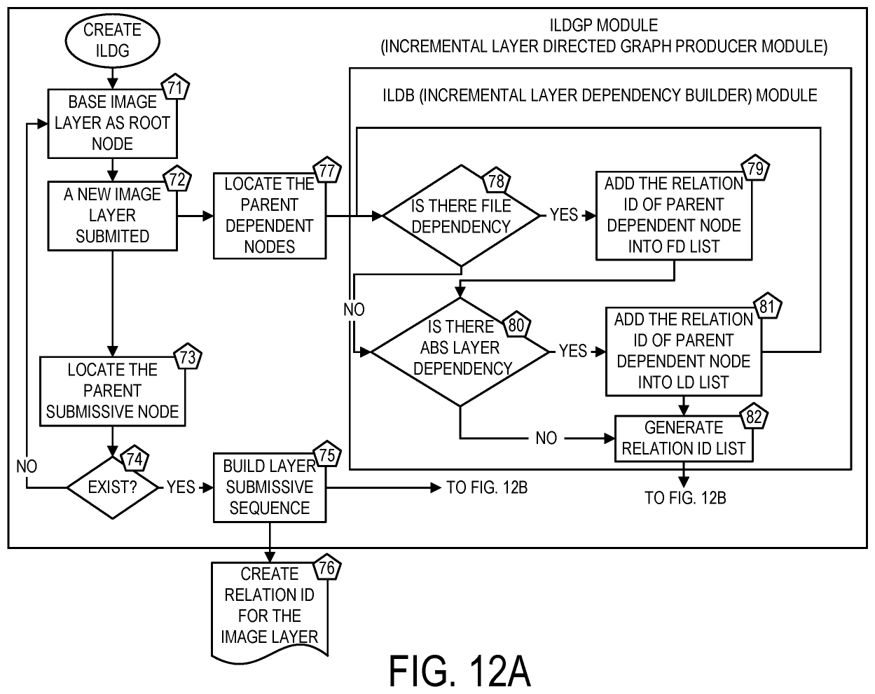

In another use case, an original relationship graph for an historical container image can be the relationship graph 200 of FIG. 11. The relationship graph 200 of FIG. 11 can be the same as the relationship graph of FIG. 7, except that the relationship graph includes the additional nodes that specify layers 6 and 7, and there is an additional abstraction layer dependency (e) between node 1 and node 5. In the described example of FIG. 11, a reduced relationship graph for FIG. 11 can be the reduced relationship graph of FIG. 10, wherein the targeted layer is layer 5. Nodes 3 and 4 can be removed as a result of node 3 and 4 being absent from the described file dependency list (FD list) for layer 5 and the described abstraction layer dependency list (LD list) for the targeted historical certain layer, layer 5. The reduced relationship graph as shown in FIG. 10 specifies the targeted layer and a subset of layers of the original container image preceding the targeted layer. Graph driver 110 can use the relationship graph specifying the targeted layer and a subset of layers for selecting layers for download in the producing of a new container image. The layers for download can include the targeted layer and the specified subset of layers preceding the targeted later.

According to one aspect, graph driver 110 in the producing of the reduced graph can remove duplicated dependencies that are duplicated between file dependency sequence list and an abstraction layer dependency list. Referring to FIG. 11, the dependency between layer 5 and layer 1 is referenced on both the file dependency sequence list and an abstraction layer dependency list. Accordingly, the duplicated dependency can be removed from one of the file dependency sequence list and an abstraction layer dependency list when a cumulative relation ID list is generated.

In response to completion of analyzing block 1107 which can include providing of a reduced relationship graph specifying the targeted layer and a subset of layers of the historical container image preceding a targeted layer, graph driver 110 can proceed to send block 1108. At send block 1108, graph driver 110 can send relationship data defining the reduced graph to resource 120 which resource 120, at send block 1204 can use the relationship data to query container image repository 108. Responsively to the query, container image repository 108 at block 1083 can send selective container data defined by the selected layers specified in the reduced graph to resource 120. Container data sent at block 1204 can include binarized container layer image data defining the selected layers and/or build file data for building the selected layers.

Resource 120 at build block 1205 in response to the receipt of the selective container data sent at block 1083 can build a new container image based on a container build file. The new container image can include the selected subset of layers of the original historical container image selected by the reduced graph generation, as well as any new one or more layer that is specified by developer user who is using a container image build file tool, wherein container build file data has resulted in the sending of the container request data at block 1701. In the case a DOCKER® container platform is used, the text based build file can be provided by a “DOCKER® file” (DOCKER® is a registered trademark of Docker, Inc.). A built container image can include, e.g., code, libraries, configuration files, and environment variables.

On completion of build block 1205, resource 120 can proceed to test block 1206 at which block resource 120 can subject a build container image built at block 1205 to testing. Testing can be commenced on receipt of test command data sent at block 1702. Container image testing at test block 1206 can include running the container image to define a runtime container. The runtime test environment of resource 120 can include, e.g., simulated clients simulating actions of client UE devices in a production environment. The runtime test environment can include logging agents that produce logging data that specifies performance attributes of the runtime container of the test environment. Resource 120 can perform examining of logging data to identify container application errors defining container error data. Examples of container application errors can include, e.g., node block tree (NBT) errors, file truncation errors, checksum errors, syntax errors, and caching errors. Resource 120 can display and present output data 174, e.g., logging data, and/or error report data on user interface 172 as depicted in FIG. 11. In dependence on the examining of the logging data resource 120 at 1207 can ascertain whether performance has satisfied a criterion for passing the container to production. The criterion can be, e.g., that no errors are identified, or that certain predetermined errors are not identified, or that a number of errors across various types below a threshold are identified. At block 1207 resource 120 can examine administrator developer input that adjusts the criterion for passing or failing a container based on observation of the output data 174. On the determination that a container has passed, resource 120 can proceed to return block 1208.

On the determination at block 1207 that the container has failed, resource 120 can message UE user interface 172 to prompt for updated container request data and resource 120 can return to a stage preceding block 1203 to receive updated container request data sent at a next iteration of container request data defined by an administrator developer user using user interface 172 responsively to the prompting.

At a first iteration of block 1202 in one embodiment, the historical container for storage into container image repository 108 including the targeted layer can be minimally encoded to record a minimal number of dependency types. For example, the historical container image can record file dependencies between layers but not abstraction layer dependencies. In such an embodiment, an administrator developer user at send block 1701 can send user defined data specifying additional dependencies, namely abstraction layer dependencies between layers.

For defining such user defined dependency data, user interface 172 can present and display a representation of relationship graph 200 as shown in FIG. 11 which can be a relationship graph for the historical container image having a targeted layer and being used by an administrator developer user for building a new container image. The user interface can present highlights as indicated by the edge labels indicated in FIG. 11 to indicate the edges for which dependencies have already been specified, so that the user is aware of layers having no currently specified dependency. Thus, based on the intelligent feedback of user interface 172, a user can add dependencies to the historical container image being used to build a new container image. The updated dependency data can be sent to container image repository 108 at messaging blocks 1203, and 1106. User interface 172 in one aspect can indicate and present visualizations of file dependencies and abstraction layer dependencies differently (e.g., medium texture labels file dependencies, or no texture labels for abstraction layer dependencies as indicated by the visualization of FIG. 11). In one aspect, an administrator developer user can submit different download selections through user interface 172 which can be configured so that the administrator developer user can specify for download container image layers in abstraction layer dependency relation independent of container image layers in file dependency relation.

In the described embodiment, a first iteration of built container built for testing at a first iteration of build block 1205 can include a first count of layers from the historical container image and a second iteration of a built container built at a second iteration of block 1205 can include a second count of layers (greater than the first) from the historical container image (based on an additional one or more abstraction layer dependency being specified). Accordingly, the described testing and user interface features permit an administrator developer user to specify incrementally built up succession of container images and runtime containers, each taking one or more additional layer from the historical container image.

Thus, by the described features, a user can be empowered to develop a succession of container images and containers wherein the earliest container is relatively lightest in weight, and the succession can become incrementally more featured as performance data is observed. The use case enables an administrator developer user to discover a minimally weighted container that is satisfactorily operational, beginning with a relatively de-featured subset of layers. According to the use case described, a user can initially build a new container with only file dependencies (but not abstraction layer dependencies) encoded in the historical container having the targeted layer for inclusion in a new container image. Then, after testing the first iteration, the user can add dependencies (including abstraction layer dependencies) to the historical container image having the targeted historical layer.

In another embodiment, the historical container image stored in container image repository 108 having the targeted layer can be comprehensively encoded to include both file dependencies and abstraction layer dependencies recorded. However, at an iteration of block 1701 and block 1203, selection data for selection of a targeted layer, and dependent layers thereon can be configured for selection of only select dependencies, e.g., just file dependencies but not the recorded abstraction layer dependencies. At this initial stage, user interface 172 (FIG. 11) can present user understandable indicators on the edges where additional dependencies are available for selecting but are not active (e.g. can be displayed according to a distinctive format). Thus, with abstraction layer dependencies disregarded, selected container image data sent at block 1083 can have reduced features and can be without layers having abstraction layer dependencies (but can include layers having file dependencies). The built new container image built at an earlier iteration of block 1025 can be without layers of the historical layers having recorded abstraction layer dependencies. For testing of the newly built container image the newly built container image can be built and run. On failure of testing at block 1207, resource 120 can return to a stage preceding block 1203 and UE device 170 having user interface 172 can be activated to present new prompting data to prompt an administrator developer user to select additional layer dependencies. At this stage the user can select one or more additional dependency that is available but not active. In one example, user interface 172 can have a special control to allow selection of container data processing identified abstraction layer dependencies from a repository stored historical container image without selection of manual flag specified abstraction layer dependencies, wherein identification of the abstraction layer dependency was predetermined and forced by a software flag manually raised by an administrator developer user.

Graph driver 110 determining abstraction layer dependencies at block 1103 can include graph driver 110 processing container data, e.g., text based build file code data, text based container image building logging data generated as a result of building and/or committing of a container image, and/or text based runtime logging data generated as a result of running of a runtime container (container data processing identified abstraction layer dependencies). Additionally or alternatively, processing at block 1103 can include graph driver 110 for examining one or more image layer reading a software flag defined by a developer user (manual flag specified abstraction layer dependencies). Such a software flag can be defined, e.g., with use of an administrator developer user interface 172 of administrator UE device 170 in developing a container image for uploading, as described herein in reference to block 1201. User interface 172 in one aspect can indicate and present visualizations for file dependencies and abstraction layer dependencies differently (e.g., medium texture labels file dependencies, no texture labels for abstraction layer dependencies as indicated by the presented visualization of FIG. 11). In one aspect, an administrator developer user can submit different download selections through user interface 172 which can be configured so that the administrator developer user can specify for download container image layers in abstraction layer dependency relation independent of container image layers in file dependency relation.

Accordingly, the described testing and user interface features permit an administrator developer user to specify an incrementally built up succession of container images and containers, each taking one or more additional layer from the historical container. Thus, a user can be empowered to develop a succession of container images and containers wherein the earliest container is relatively lightest in weight, and the succession can become incrementally more featured as performance data is observed. The use case enables an administrator developer user to discover a minimally weighted container that is satisfactorily operational, beginning with a relatively de-featured subset of layers taken from an historical container image. According to the use case described, a user can initially build a new container with only file dependencies encoded in the historical container having the targeted layer for inclusion in a new container image. Then, after testing the first iteration, the user can add dependencies to the historical container image having the targeted historical layer. The user additionally or alternatively can deactivate any active dependency in any iteration.

In yet another embodiment, an initially built container image built at block 1205 and tested at block 1206 can include layers based on all recorded dependencies from the historical container image of container image repository 108 having the historical targeted layer. The built container image that is run at block 1206 can be operational and functional but a user can define a criterion evaluated at block 1207 to result in return of resource 120 to a stage preceding block 1203, and UE device 170 to block 1701 to present prompting data prompting the user to remove active dependencies from the historical container of container image repository from which the new container was built. Then, the user can deselect one or more active dependency (active and inactive dependencies indicated with different indicators, e.g., inactive in grayscale, active in color).

Through multiple iterations of building and testing in this described embodiment, a user can iteratively remove layers from an historical container that are selected in the building of the new container. An advantage of such a use case is that the user can identify in a systematic way a container that is satisfactorily lightweight and satisfactorily operational. The user additionally or alternatively can activate any inactive dependency in any iteration, e.g., for identification of a container that is satisfactorily lightweight and satisfactorily operational.

On completion of block 1207 resource 120 can proceed to return block 1208. At return block 1208, resource 120 can return to run block 1201 to run the new container, e.g., in a production environment. With the running of the new container, resource 120 can commit the new container image subject to testing at block 1206 to container image repository 108 and a next iteration of blocks 1101-1104 can be performed for generating dependency relationship data characterizing the new container.

Resource 120 can iteratively perform the loop of blocks 1201-1208 for a deployment period of resource 120 and can simultaneously be performing multiple instances of blocks 1201-1208 on an iterative basis.

Graph driver 110 can iteratively perform the loop of blocks 1101-1109 for a deployment period of graph driver 110 and can simultaneously be performing multiple instances of blocks 1101-1109 on an iterative basis.

Container image repository 108 can iteratively perform the loop of blocks 1081-1084 for a deployment period of container image repository and can simultaneously be performing multiple instances of blocks 1081-1084 on an iterative basis.

UE device 170 can iteratively perform the loop of blocks 1701-1703 for a deployment period of UE device 170 and can simultaneously be performing multiple instances of blocks 1701-1703 on an iterative basis.

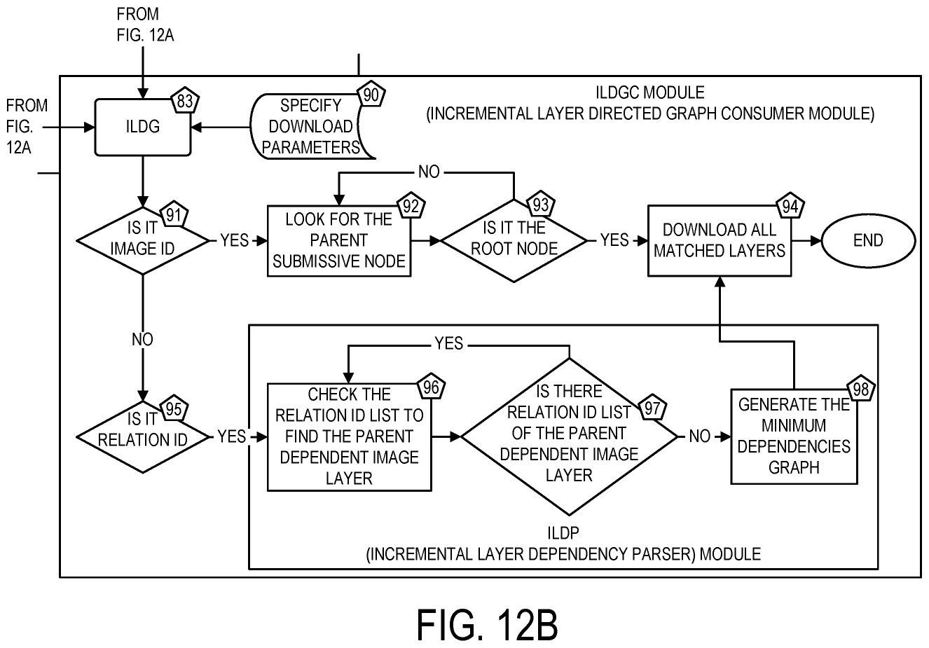

FIGS. 12A-12B is a workflow that illustrates various aspects of graph driver 110 that generate the dependencies between the image layers and generates a container. For ease of understanding, various aspects are separated into first and second modules, an incremental layer directed graph producer (ILDGP) module and an incremental layer directed graph consumer (ILDGC) module, but this is merely one suggestion for a possible configuration of graph driver 110.

In some examples, graph driver 110 running the incremental layer directed graph producer (ILDGP) module generates a relationship graph 200 provided by an incremental layer directed graph (ILDG) (e.g., directed graph) or any other structure in which dependencies between image layers can be represented. To generate the ILDG (or similar structure), graph driver 110 can set a base layer image as a root node at block 71. Graph driver 110 can obtain a submission of given image layer at block 72. In order to generate the ILDG, graph driver 110 can evaluate each image layer in turn. FIGS. 12A-12B illustrate graph driver 110 of the ILDGP module evaluating a given layer. Graph driver 110 repeats the illustration workflow to evaluate each layer based on an order of submission of the layers. The examining at block 72 can be performed concurrently with the submission of each new layer defining a container image into container image repository 108, or can be performed layer by layer based on time order of submission after all layers forming a container image are uploaded into container image repository 108. The examining at block 72 can include analyzing time stamps that specify submission times of respective layers defining a container image.

In FIG. 12A-12B, upon submission of the layer, graph driver 110 can locate at block 73 a parent submissive layer and if a parent submissive layer is determined to exist at block 74 graph driver 110 can proceed to block 75. At block 75, graph driver 110 can build a layer submissive sequence.

When graph driver 110 determines that there is a submissive sequence between submitted layer submitted at block 72 and its parent node, graph driver 110 can build a submissive sequence at block 75. To mark the submissive sequence, graph driver 110 can generate a relation ID for the newly submitted image layer at block 76. Graph driver 110 can calculate a relation ID for each layer by submitting all the ancestor submissive layers' image IDs through a hash algorithm (e.g., SHA256). For example, relation_ID_{L5}=SHA256 (Image_ID_{LB}+Image_ID_{L1}+ . . . +Image_ID_{L4}).

Graph driver 110 while examining incoming submitted layers for time submission relationships can also or alternatively be examining incoming submitted layers for file dependencies and/or abstraction layer dependencies.

Graph driver 110 examining submitted layers for file dependencies can ascertain whether a submitted layer modifies a common file with the submitted layer. Graph driver 110 examining submitted layers for abstraction layer dependencies can, e.g., process container data to ascertain that a submitted layer and another layer communicate and share data with one another or can e.g., process container data to ascertain that a submitted layer and another layer use common resource. Graph driver 110 examining submitted layers for abstraction layer dependencies can include graph driver 110 for examining an image layer ascertaining that a user has raised a manually defined flag associated to the image layer so that identification of an abstraction layer dependency is predetermined and forced.

Referring further to the flowchart of FIG. 12A, graph driver 110 at block 78 can examine container data to ascertain whether a submitted layer is in file dependency with its immediate parent layer. Based on graph driver 110 ascertaining that a submitted layer is in file dependency with its immediate parent layer, graph driver 110 at block 79 can add a relation ID for the parent layer into a file dependency (FD) list for the submitted layer. Graph driver 110 on determining that the submitted image layer does not have a parent dependent layer can designate the submitted image layer as a file dependency dependent child of the root layer (i.e., base layer) at block 78. Embodiments herein recognize that each layer of the container stores changed content, and that downloading a certain layer with the base layer can provide assurance that the complete functionality of the certain layer can be provided. Therefore, each layer can be in file dependency relation to the base layer.

Referring further to the flowchart of FIG. 12A, graph driver 110 can proceed to block 80 either on determining that the submitted layer is not file dependent on another layer (block 78) or on providing an FD list for the submitted layer (block 79). At block 80 graph driver 110 can ascertain whether there is a layer in abstraction layer dependency with the current submitted layer. Graph driver 110 at block 80 can examine container data to ascertain whether a submitted layer is in abstraction layer dependency with its immediate parent layer (or can identify an abstraction layer dependency based on reading a manually raised software flag raised by an administrator developer user to predetermine and force the identification of an abstraction layer dependency). Based on graph driver 110 ascertaining that a submitted layer is in abstraction layer dependency with its parent layer, graph driver 110 at block 81 can add a relation ID for the parent layer into an abstraction layer dependency (LD) list for the submitted layer.

On completion of block 80 or block 81, graph driver 110 can proceed to block 82 to generate a cumulative dependency list of layers from the FD list and the LD list, which can be referred to as a cumulative dependency relation ID list (which can alternately be termed a generical relation ID list). The cumulative dependency relation ID list for the submitted layer can include references (relation IDs) for layer references on either of the FD list or the LD list for the submitted layer.

Graph driver 110 can remove duplicate references to a certain layer that are referenced on both of the FD list and the LD list for the submitted layer as explained with reference to FIG. 11 (dependencies listed as dependencies (c) and (e) between layer 5 and layer 1 reduced to one dependency). Graph driver 110 on completion of block 82 and block 75 can proceed to block 83 (FIG. 12B). At block 83, graph driver 110 can produce a relationship graph 200 provided by an incremental layer directed graph (ILDG), examples of which are shown in FIGS. 8 and 11.

FIG. 12B sets forth functions of incremental layer directed graph consumer module (ILDGC) that consumes the produced relationship graph 200 (FIG. 8, FIG. 11) that can be produced by the process depicted in FIG. 12A. Wherein FIG. 12A depicting an ILDGP module specifies operations of graph generating process 111 in one embodiment, FIG. 12B depicting an ILDGC module specifies operation of graph consuming process 115 in one embodiment.

Graph driver 110 running the ILDGC module can obtain at block 90 download parameters from a resource 120 of a computing system that include a request for elements comprising a given image layer. In one embodiment, block 90 can correspond to block 1203 of FIG. 6. Graph driver 110 at block 91 can parse the parameters for identification of an image ID, and based on the identification of the image ID can proceed to block 92 to look for parent submissive layers and by performance of block 92 and block 93 (determination of whether the base layer has been found) can identify a time submissive sequence of all submitted layers (edges listed with numbers in FIGS. 8 and 11).

At block 91 for parsed parameters that are not image IDs (triggering locating of time submission sequence), graph driver 110 can proceed to block 95. At block 95 graph driver 110 can identify a cumulative dependency relation ID list for the targeted layer. On identification of a cumulative relation ID list, graph driver 110 can proceed to block 96. At blocks 96 and 97 graph driver 110 can analyze the targeted layer and preceding layers back to the earliest layer (possibly the base layer) to obtain a complete identification of file and/or abstraction layer dependencies. At block 98, graph driver 110 can output a minimal dependency graph based on the identification of all identified layers defining one or more of file dependency sequence or layer dependency sequence, and matching to the time submission sequence of layers to remove layers from the time submission sequence for production of a reduced relationship graph, as referenced and shown in FIG. 1 and FIG. 10. The reduced relationship graph as referenced and shown in FIG. 1 and FIG. 10 can specify the targeted layer and a subset of layers of the historical container image preceding the targeted layer. Graph driver 110 can use the relationship graph 200 defining a reduced relationship graph, e.g., as shown in FIG. 10 specifying the targeted layer and the subset of layers preceding the targeted layer for selecting layers for download in the producing of a new container image.

On completion of block 93 and block 98, graph driver 110 can proceed to block 94. At block 94, graph driver 110 can download matching layers from the time submission sequence listing of layers associated to the targeted layer, and the cumulative dependency sequence of layers. Comparing FIG. 7 and FIG. 10, graph driver 110 can identify layers LB, L1, L2, and L5 as matching from the time submission sequence LB, L1, L2, L3, L4, and L5 and the cumulative file dependency and abstraction layer dependency sequence of layers LB, L1, L2, and L5 to download the sequency of layers LB, L1, L2, and L5 according to a timing based on the time order indicated on the time submission sequence list.

Comparing the ILDGB module as shown in FIG. 12A to the ILDGC module as shown in FIG. 12B it can be seen that for operation of graph generating process 11I graph driver 110 can, in one embodiment, identify only direct dependencies of a given layer under analysis in the making the FD and LD lists as set forth herein (single hop crawling). However, for operation of graph consuming process, graph driver 110 can “crawl back” multiple layers phase provides for simple and reliable implementation while facilitating the reliable identification (see blocks 96 and 97 of FIG. 12B) when identifying multiple hop sequences of dependent layers that are dependent by being file dependent and or abstraction layer dependent on another layer. The described arrangement wherein only direct dependencies (and not multihop indirect dependencies) in the graph generating phase provides for simple and reliable implementation while facilitating the reliable identification (see blocks 96 and 97 of FIG. 12B) of mulihop indirect dependencies (see relationship graph 200 defining a reduced relationship graph as shown in FIG. 10) in the consuming phase.

Embodiments herein recognize that in existing systems, when committing a container image, there can be packaged all the contents of the image layers, and the contents can be pushed to a container image repository in the form of a container image. When pulling a container image from a container image repository in an existing system, there can be downloaded all the contents of a target image layer and all parent layers of the target to a local resource.

Embodiments herein recognize that installation of all updated packages associated to all parent layers of a targeted layer can impose risk since some updates affect the existing production environment which sometimes triggers unexpected results. Accordingly, embodiments herein recognize that in some use cases, advantages can be yielded by installation of only a subset of available updates, e.g., HIPER packages (potential outages or security fixes). Embodiments herein recognize that an image provider, i.e., the z/OS build team, can be challenged to provide a separate repository or build specified images for all customers. Embodiments herein can provide support to users to flexibly install and deploy applications on containers on demand, with downloading of a subset of preceding parent image layers of a targeted layer of an historical container image having the targeted layer.

Embodiments herein can provide updated image deployment with reduced impact to the user environment. File dependency and abstraction layer dependency can be used to build layer dependencies at the physical file level (OSI physical layer) and at an abstraction layer, respectively. In another aspect, attributes of an image layer including a file dependencies list and an abstraction layer dependencies list can be introduced to record a dependency relation ID list.

An incremental layer dependency builder module in a graph driver 110 can generate a file dependencies list and abstraction layer dependencies list which can be used to build a dependency relation ID list. The incremental layer dependency parser module in a graph driver can analyze the dependency relation ID list to build a dependency graph during pulling of a container image from a container image repository and can make the deployment of updated services or layers on demand through containers.

Embodiments herein can provide a method that reduces impact of an updated image deployment on a user environment with use of features that determine the dependencies of image layers while maintaining integrity of an application.

File dependency and abstraction layer dependency can be used to record dependencies at the physical files level (physical layer) and at an abstraction layer, respectively. Attributes provided by a file dependencies list and an abstraction layer dependencies list can be used to build a dependency relation ID list. In one aspect a file dependencies list can record the relation ID of all image layers that have direct file dependencies. A cumulative layer dependencies list can record the relation ID of all images that have direct abstraction layer dependencies.

In one aspect, a relation ID list can store cumulative unique layer dependencies from the file dependencies list and layer dependencies list after the duplicate removal. An incremental layer dependency builder module can be introduced into a graph driver 110 during committing an image to an image repository.

Embodiments herein can generate a file dependencies list and abstraction layer dependencies list after examining file dependency and layer dependency, and then can build a new relation ID list with use of a file dependencies list and a layer dependencies list. An incremental layer dependency parser module can be introduced into graph driver 110 during downloading a container image from the repository. Graph driver 110 can parse the relation ID list to build a dependency graph and pull a reduced set of layers.

Embodiments herein provide an intelligent and efficient method to provide updated image deployment with reduced impact on a user environment. File dependency and layer dependency can be provided to build layer dependencies at the physical files level and at an abstraction layer respectively. Attributes of an image layer including a file dependency (FD) list and an abstraction layer dependency (LD) list can be provided for recording of a cumulative dependency relation ID list. An incremental layer dependency builder module (ILDB) in graph driver 110 can generate an FD list (file dependencies list) and an LD list (abstraction layer dependencies list) which are used to build a dependency relation ID list.

An incremental layer dependency parser (ILDP) module in graph driver 110 can parse the dependency relation ID list to build a dependency graph during pulling the image from a container image repository and makes the deployment of updated services or layers on demand through containers.

Embodiments herein allow users to download images on demand for more flexible and efficient application deployment with reduced impact on the user environment. Embodiments herein can be transparent to both a developer and an end user of the image.

Embodiments herein can provide updated image deployment with reduced impact on a user environment. Embodiments herein can provide determining dependency of image layers for purposes of removing layers from a downloaded historical container image while maintaining integrity of the application. File dependency and abstraction layer dependency can be used to record layer dependencies at the physical file level and at an abstraction layer respectively. File dependency can be used to record file dependencies between different image layers after analyzing the file modification. Abstraction layer dependencies can be identified and can be used to record abstraction layer dependencies. Abstraction layer dependencies can be identified by processing container data or can be identified by reading an administrator developer user specified flag that predetermines the identification of an abstraction layer dependency.

An image layer FD list (file dependencies list) and the LD list (abstraction layer dependencies list) can be used to build the cumulative dependency relation ID list. In one aspect an FD list (file dependencies list) can record the relation ID of all images that have direct file dependencies. An LD list (layer dependencies list) can record the relation ID that has direct layer dependency with a given layer. A cumulative relation ID list can store a unique set of cumulative dependencies from the FD list and LD list with duplicate removal.

An ILDB (incremental layer dependency builder) module of graph driver 110 can operate during committing an image to a repository. The ILDB can generate an FD list (file dependencies list) and LD list (abstraction layer dependencies list) after analyzing file dependency and abstraction layer dependency, and then can build a cumulative dependency relation ID list with use of the FD list and LD list.

An ILDP (incremental layer dependency parser) module of graph driver 110 can operate during downloading a container image from a container image repository. The ILDP module can parse the cumulative dependency relation ID list to build a dependency graph and can pull the least matched layers.

In one aspect, as shown in FIGS. 7 and 8, container data can be examined to identify and record file dependency of different image layers. Graph driver 110 can record various file dependencies indicated with medium texture shaded alphabet letters. In FIG. 7 and FIG. 8 there are shown the file dependencies (a), (b), and (c) where graph driver 110 has determined that first and second layers (e.g., layer L5 and L1, L1 and LB, L2 and LB in FIG. 5) have modified a common file, graph driver 110 can record a file dependency.

According to union mount, the unified view presented to the user after the mount can include the last modified files (e.g., referring to FIG. 9, file_3 is modified in L5 and L1, but file_3 in mount point is same to file_3 in L5). Referring to the relationship graph 200 of FIG. 8 and the spreadsheet of FIG. 9, (c) demonstrates the file dependency between L5 and L1 in FIG. 8). Union mount technology is a mount technology that can be built on the file system, which can merge different directories in the original underlying file system and present the merged file system to the users.

In another aspect, graph driver 110 can examine container data for recording abstraction layer dependencies between different image layers. In one embodiment, abstraction layer dependencies can be determined based on operation of an automated process, wherein graph driver 110 can examine container data, as set forth herein. In one embodiment, abstraction layer dependencies can be administrator developer user specified. In FIG. 7 and FIG. 8, the dependency (d) between layer 5 and layer 2 can be an abstraction layer dependency. Dependency (d) demonstrates abstraction layer dependency between L5 and L2 in FIGS. 7 and 8.

Embodiments herein can include generating an FD list and an LD list and using the FD list and the LD list to generate a cumulative relation ID list and a minimum dependency graph.

For generating an FD list (file dependencies list), graph driver 110 can record the relation ID of all image layers that have direct file dependencies with respective image layers subject to examination (ie. Relation Id: 5889fc . . . of Layer 1 is in the FD list: [5889fc . . . ] of Layer 5) (See dependency (c) in FIG. 7).

For generating an LD list (abstraction layer dependencies list), graph driver 110 can record the relation ID of all image layers that have direct abstraction layer dependencies with the image layer subject to evaluation (i.e., Relation ID: 575e94 . . . of Layer 2 is in the LD list: [575e94 . . . ] of Layer 5) (See Dependency (d) in FIGS. 7 and 8). Graph driver 110 can use the FD list and the LD list to generate a cumulated dependency relation ID list. The cumulative dependency relation ID list can record the unique relation ID of all image layers that have dependencies (either file dependency or abstraction layer dependency) with a given image layer.

Graph driver 110 can generate a minimum dependency graph tagged with use of the cumulative dependency relation ID list of the targeted layer during pulling container image from the container image repository.

Embodiments herein can ensure the integrity of the application when downloading the image layer on demand and can reduce the impact on the user environment. Embodiments herein can increase the speed of the deployment by reducing the image layers downloaded. Embodiments herein can provide flexibility of traditional development and testing group in a container working environment.

Embodiments herein can be transparent to end users, avoiding a need for end users to take special action during operating a container.

FIG. 8 illustrates a graph of the type that can be generated by graph driver 110 for storage into graphs area 2122 of container image repository 108. The graph of FIG. 8 is a relationship graph having nodes that specify image layers of a container image and edges between the layer edges that specify relationships between image layers. Edges having numbers with dark texture specify a submissive sequence between layers. Medium textured letters specify image layers that are in file dependency relation to other layers. Edges labeled with untextured letters specify image layers that are in abstraction layer dependency.

FIG. 9 shows a spreadsheet representation illustrating attributes of image layers defining container image corresponding to the example of FIG. 8. Darkened textured numbered labels specify image layers and submission relation to one another submissive relationships. As noted, a submissive image layer relationship can be determined using timestamp analysis, wherein the timestamps specify a time of commitment of an image layer. In the example of FIGS. 8 and 9, layer 5 is submissive to layer 4, layer 3 is submissive to layer 2, layer 2 is submissive to layer 1, and layer 1 is submissive to the base layer. Lettered medium textured layers specify image layers that are in file dependency to another layer. Image layers in file dependency relation can be layers that modify a common file. Graph driver 110 can ascertain layers in file dependency relation using container data processing as set forth herein. With further reference to FIGS. 8 and 9, labels with no texture can be layers in abstraction layer dependency relation.

FIG. 8 illustrates graph driver 110 performing relationship data generating process 113 as described in connection with FIG. 1. In one example, graph driver 110 can assign to each node associated to an image layer an image ID. As shown in FIG. 8, graph driver 110 can assign each layer associated node a unique image ID and a relation ID. Graph driver 110 can calculate a relation ID for each layer by submitting all the ancestor submissive layers' image IDs through a hash algorithm (e.g., SHA256). For example, relation_ID_{L5}=SHA256 (Image_ID_{LB}+Image_ID_{L1}+ . . . +Image_ID_{L4}).

Graph driver 110 can specify, for each layer associated node (and therefore each layer), a file dependency list, and an abstraction layer dependency list. The file dependency list for a certain image layer can be a set of relation IDs specifying image layers in direct file dependency with the certain image layer. The abstraction layer dependency list for a certain image layer can be a set of relation IDs specifying image layers in direct layer dependency relation to the certain image layer.

For example, referring to layer 2 in the described example of FIG. 8, the file dependency list can include the relation IDs: 461022 . . . to specify that the base layer is in direct file dependency relation to the current layer, layer 2. Referring to layer 2 in the described example of FIG. 8, there are no layers in abstraction layer dependency relation to layer 2. Accordingly, the abstraction layer dependency list for image layer 2 can include a null set.

In the described example of FIG. 8, only layer 5 has abstraction layer dependency with another layer. Therefore, in the described example of FIG. 8, only the node of layer 5 includes an abstraction layer dependency list (LD list) that is not a null set. Layer 5 can include the abstraction layer dependency list specifying the relation ID 575894, the relation ID for layer 2, which is in layer dependency with layer 5.

Certain embodiments herein may offer various technical computing advantages involving computing advantages to address problems arising in the realm of computer networks. Embodiments herein can ensure the integrity of an application when downloading the image layer on demand and reduce the impact on the user environment. Embodiments herein can increase the speed of the deployment by reducing the image layers downloaded. Embodiments of the present invention provide a system and method to deploy applications on-demand through container images. Unlike existing approaches, the examples herein enable a customized and targeted deployment to fulfill specific technical needs, rather than a blanket deployment of all image layers, as the latter increases both system overhead and risk. In some of the examples herein, program code executing on one or more processors deploys updated services or layers on demand through containers. In embodiments of the present invention, the program code determines dependencies between image layers when generating and deploying containers such that a user can receive a more targeted container with current and/or interdependent layers, rather than a deployment that includes unnecessary overhead. To this end, as explained in greater detail herein, the program code analyzes layers for dependencies and groups interdependent changes within the layers based on both these dependencies and on when the changes were implemented (as compared to the last image refresh of the target machine). For example, the program code can generate an ILDG (incremental layer directed graph) and utilize the ILDG to identify sequences of image layers (referred to herein as submissive sequences and dependent sequences) of the image layers. Based on understanding these dependencies, the program code can deploy updated services or layers on demand through containers without including excess content in the deployments. Program code in embodiments of the present invention deploys applications on-demand through container images based on understanding both the timing of the changes made to the image layers that comprise the containers and the dependencies between these layers. The program code can generate a directed graph and utilizes the directed graph to configure a container for deployment. When a client requests a container to update a given application, program code can generate a container without additional layers that would increase risk and overhead.

In some embodiments to deploy applications on-demand through container images, when committing images into a repository, the program code produces the incremental layer directed graph (e.g., ILDG) of image layers based on a submissive sequence and a dependent sequence. To produce the directed graph, the program code: 1) generates a dependent sequence by searching the nodes' parent dependent nodes with the modification of the files; and 2) generates a submissive sequence by searching the nodes' parent submissive nodes with the timestamps of uploading. The program code module that produces the directed graph can be referred to as an ILDGP (incremental layer directed graph producer) module. In some examples, program code also consumes an ILDG of image layers when pulling the image from the repository to graph and configure a deployment of updated services or layers (on demand) through containers. The program code that consumes the directed graph to configure the deployment can be referred to as an IRGC (incremental layer directed graph consumer) module. Embodiments of the present invention are inextricably tied to computing and are directed to a practical application. Embodiments of the present invention are rooted in computer technology and address a specific challenge in computer technology by providing a technical solution. The issue that is addressed by the examples herein is that when a container is deployed, more layers than required by the resource are deployed causing additional overhead and exposing the resource to risks. The examples herein provide a system and method for generating and deploying a container on demand that based on understanding the dependencies of the layers and when the changes to the various layers were implemented, the program code can deploy a flexible container, on-demand. The program code can generate a targeted container for deployment that does not include extra applications or features. Not only are the examples inextricably tied to computing, but the examples herein are integrated into a practical application. Embodiments of the present invention provide significantly more than existing container deployment techniques. The examples herein enable a resource to download image layers on-demand and in a manner that affects, for example, a production environment of and enterprise level customer (in which this resource resides) as little as possible, when updating and exploiting the new features or fixes. The examples herein increase the speed of deployments by reducing the image layers downloaded therein. In testing and development phases of projects, utilizing the examples herein enable testing groups to switch to container working environments. The examples herein are transparent to end users and are compatible with current container tools. Certain existing approaches focus on reducing the size of an image to preserve disk space, but the examples herein not only reduce the size but also, reduce the contents of the container in a manner that simplifies downloading, installing, and updating processes during deployment of the container. Other approaches attempt to merge image layers, but in the examples herein, the relationships between layers are understood such that layers can be excluded from a deployment. The examples herein reduce the number of layers and the amount of data of image files by determining which layers to include in a container. One or more aspects of the present invention are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing a process (or multiple processes) that, e.g., facilitates granular real-time data attainment and delivery including as relevant to soliciting, generating, and timely transmitting, granular product review to consumers. Aspects of the present invention are not limited to a particular architecture or environment. Embodiments of the present invention include computer-implemented methods, computer systems, and computer program products that comprise program code automatically generating and deploying applications on-demand through container images. In some examples, the program code obtains a first container. The first container includes image layers, where the image layers include a base image layer and one or more image layers. The program code determines dependencies between the image layers. The program code obtains a request for an application, where at least one image layer of the one or more image layers comprises features of the application. The program code can identify, based on the dependencies, at least one additional image layer related to the at least one image layer. The program code generates and deploys a second container, where image layers of the second container consist of the at least one image layer, the at least one additional image layer related to the at least one image layer, and the base layer. Certain embodiments may be implemented by use of a cloud platform/data center in various types including a Software-as-a-Service (SaaS), Platform-as-a-Service (PaaS), Database-as-a-Service (DBaaS), and combinations thereof based on types of subscription

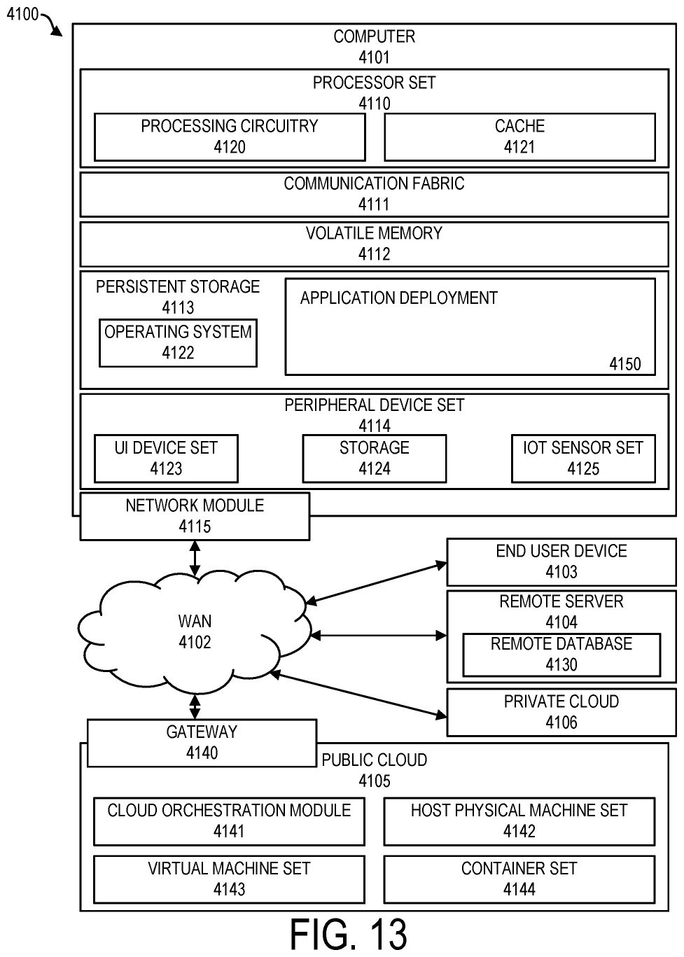

In reference to FIG. 13 there is set forth a description of a computing environment 4100 that can include one or more computer 4101. In one example, computing node 10 as set forth herein can be provided in accordance with computer 4101 as set forth in FIG. 13.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 13. In one aspect, a computing environment 4100 contains an example of an environment for the execution of at least some of the computer code involved in performing the inventive methods, such as code 4150 for container based application deployment described with reference to FIGS. 1-12. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113.

Persistent storage 4113 may be a read only memory (ROM), but typically at least a portion of the persistent storage allows writing of data, deletion of data and re-writing of data. Some familiar forms of persistent storage include magnetic disks and solid state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101), and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way, but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description, but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
examining image layers of a container image and generating, in dependence on the examining, layer dependency relationship data that specifies layer dependency relationships of the container image;
storing in a container repository the layer dependency relationship data that specifies layer dependency relationships of the container image;
in response to receipt of a download request that specifies a targeted layer of the container image, analyzing relationship data of the layer dependency relationship data;
in dependence on the analyzing, identifying a subset of image layers of the container image preceding the targeted layer; and
establishing a deployment container image in dependence on the identified subset of image layers.

2. The computer implemented method of claim 1, wherein the layer relationship data specifies file dependencies of first image layers of the container image, and abstraction layer dependencies of second image layers of the container image.

3. The computer implemented method of claim 1, wherein the establishing a deployment container image in dependence on the identified subset of image layers includes selecting for deployment image layers that are in abstraction layer dependency with the targeted layer.

4. The computer implemented method of claim 1, wherein the establishing a deployment container image in dependence on the identified subset of image layers includes selecting for deployment image layers that are in file dependency with the targeted layer, wherein the establishing a deployment container image in dependence on the identified subset of image layers includes selecting for deployment image layers that are in abstraction layer dependency with the targeted layer.

5. The computer implemented method of claim 1, wherein the establishing a deployment container image in dependence on the identified subset of image layers includes selecting for deployment image layers that are file dependent on the targeted layer, wherein the establishing a deployment container image in dependence on the identified subset of image layers includes selecting for deployment image layers that are abstraction layer dependent on the targeted layer and wherein a layer order for downloading of layer images of the subset of image layers from the container image is dependent on time of submission of the subset of image layers.

6. The computer implemented method of claim 1, wherein the layer relationship data specifies abstraction layer dependencies of image layers of the container image.

7. The computer implemented method of claim 1, wherein examining includes identifying one or more abstraction layer dependency of the container image.

8. The computer implemented method of claim 1, wherein examining includes identifying one or more abstraction layer dependency of the container image, wherein the identifying the one or more abstraction layer dependency of the container image includes reading administrator developer user defined data that predetermines the one or more abstraction layer dependency of the container image.

9. The computer implemented method of claim 1, wherein examining includes identifying one or more abstraction layer dependency of the container image, wherein the identifying the one or more abstraction layer dependency of the container image includes processing container data of the container image.

10. The computer implemented method of claim 1, wherein examining includes identifying layers of the container image that are in abstraction layer dependency, wherein the layers of the container image that are in abstraction layer dependency include each of (a) respective layers of the container image that use a common resource, (b) different layers of the container image, wherein a first of the different layers shares data with a second of the different layers, (c) complementary layers of the container image that are complementary such that runtime production advantages are yielded when the complementary layers of the container image operate together.

11. The computer implemented method of claim 1, wherein the examining includes identifying one or more file dependency of the container image, wherein the identifying the one or more file dependency of the container image includes processing container data of the container image, wherein the examining includes identifying one or more abstraction layer dependency of the container image, wherein the identifying the one or more abstraction layer dependency of the container image includes processing container data of the container image to ascertain one or more of the following selected from the group consisting of (a) respective layers of the container image that use a common resource, (b) different layers of the container image, wherein a first of the different layers shares data with a second of the different layers, (c) complementary layers of the container image that are complementary such that runtime production advantages are yielded when the complementary layers of the container image operate together.

12. The computer implemented method of claim 1, wherein the generating, in dependence on the examining, layer dependency relationship data includes generating a relationship graph having nodes associated to layers of the container image and edges referencing dependencies between layers of the container image, wherein the analyzing relationship data includes producing a reduced relationship graph having a reduced number of the nodes preceding the targeted layer relative to the relationship graph, and using the reduced relationship graph for performing the establishing the deployment container.

13. The computer implemented method of claim 1, wherein the method includes subsequent to the establishing the deployment container image, providing a subsequent deployment container image using the container image, wherein the deployment container image and the subsequent deployment container image download a different count of layers from the container image.

14. The computer implemented method of claim 1, wherein the method includes subsequent to the establishing the deployment container image, providing a subsequent deployment container image using the container image, wherein the stored relationship data for the container image specifies one or more of the following selected from the group consisting of dependent layers of the container image in file dependency relation to one another and dependent layers of the container image in abstraction layer dependency with one another, wherein the deployment container image and the subsequent deployment container image download a different count of layers from the container image based on an administrator developer user submitting different download selections through a user interface, wherein the user interface is configured so that the administrator developer user can specify for download container image layers of the container image in abstraction layer dependency relation independent of container image layers of the container image in file dependency relation.

15. The computer implemented method of claim 1, wherein the method includes subsequent to the establishing the deployment container image, providing a subsequent deployment container image using the container image, wherein the stored relationship data for the container image specifies one or more of the following selected from the group consisting of dependent layers of the container image in file dependency relation to one another and dependent layers of the container image in abstraction layer dependency with one another, wherein the deployment container image and the subsequent deployment container image download a different count of layers from the container image based on an administrator developer user submitting different download selections through a user interface configured to permit administrator developer user selection of dependent layers for download, wherein the user interface presents representations of layers of the container image in abstraction layer dependency with a different visualization relative to layers of the container image in file dependency, and wherein the user interface is configured so that the administrator developer user can specify for download container image layers of the container image in abstraction layer dependency relation independent of container image layers of the container image in file dependency relation.

16. The computer implemented method of claim 1, wherein the method includes subsequent to the establishing the deployment container image, providing a subsequent deployment container image using the container image, wherein the deployment container image and the subsequent deployment container image download a different count of layers from the container image.

17. The computer implemented method of claim 1, wherein examining includes identifying layers of the container image that are in abstraction layer dependency, wherein the layers of the container image that are in abstraction layer dependency include one or more of the following selected from the group consisting of (a) respective layers of the container image that use a common resource, (b) different layers of the container image, wherein a first of the different layers shares data with a second of the different layers, (c) complementary layers of the container image that are complementary such that runtime production advantages are yielded when the complementary layers of the container image operate together.

18. The computer implemented method of claim 1, wherein examining includes identifying layers of the container image that are in abstraction layer dependency, wherein the layers of the container image that are in abstraction layer dependency include one or more of the following selected from the group consisting of (a) respective layers of the container image that use a common resource, (b) different layers of the container image, wherein a first of the different layers shares data with a second of the different layers.

19. A computer program product comprising:
a computer readable storage medium readable by one or more processing circuit and storing instructions for execution by one or more processor for performing a method comprising:
examining image layers of a container image and generating, in dependence on the examining, layer dependency relationship data that specifies layer dependency relationships of the container image;
storing in a container repository the layer dependency relationship data that specifies layer dependency relationships of the container image;
in response to receipt of a download request that specifies a targeted layer of the container image, analyzing relationship data of the layer dependency relationship data;
in dependence on the analyzing, identifying a subset of image layers of the container image preceding the targeted layer; and
establishing a deployment container image in dependence on the identified subset of image layers.

20. A system comprising:
a memory;
at least one processor in communication with the memory; and
program instructions executable by one or more processor via the memory to perform a method comprising:
examining image layers of a container image and generating, in dependence on the examining, layer dependency relationship data that specifies layer dependency relationships of the container image;
storing in a container repository the layer dependency relationship data that specifies layer dependency relationships of the container image;
in response to receipt of a download request that specifies a targeted layer of the container image, analyzing relationship data of the layer dependency relationship data;
in dependence on the analyzing, identifying a subset of image layers of the container image preceding the targeted layer; and
establishing a deployment container image in dependence on the identified subset of image layers.
